(19) United States
(12) Patent Application Publication
(10) Pub. No.: US 2025/0096602 A1
(43) Pub. Date: Mar. 20, 2025

(54) ENERGY STORAGE UNIT CENTRAL NERVOUS SYSTEM

(71) Applicant: Torus Inc., South Salt Lake, UT (US)

(72) Inventors: Nathan Walkingshaw, Sandy, UT (US); Zahra Dersfshi, Wayland, MA (US); Weston Bridgewater, Commerce Township, MI (US); John Loveless, Layton, UT (US); Trenton Bond, Provo, UT (US); Leslie Springer, Coalville, UT (US)

(21) Appl. No.: 18/965,873

(22) Filed: Dec. 2, 2024

Related U.S. Application Data
(63) Continuation-in-part of application No. 18/620,605, filed on Mar. 28, 2024, now Pat. No. 12,211,110.
(60) Provisional application No. 63/605,410, filed on Dec. 1, 2023.
(60) Provisional application No. 63/492,778, filed on Mar. 28, 2023.

(51) Int. Cl. H02J 13/00; H02J 3/38

(52) U.S. Cl. CPC H02J 13/00002; H02J 3/381; H02J 2300/24; H02J 2300/28

(57) ABSTRACT

A system may include a battery storing energy mechanically or chemically. A system may include an inverter coupled with the battery and converting direct current from the battery to alternating current for use by one or more loads. A system may include a control system coupled with one or more power sources, the energy storage unit, and the one or more loads, the control system including: one or more electrical circuits electrically coupling one or more electrical switches that route current between the one or more power sources and the one or more loads, the one or more power sources including the inverter; and a controller communicatively coupled with the inverter and the one or more electrical switches.

### BACKGROUND

The present disclosure relates to addressing faults in local power-production or storage devices, such as flywheel energy storage systems. The disclosure also relates to various hardware components associated with energy storage systems.

Commonly, excess or backup power, such as that produced by solar panels or wind turbines, is stored in chemical storage, such as large chemical batteries. More-recently, other local power storage solutions have included gravity or kinetic energy storage, such as flywheels. Unfortunately, because they are often local to residences, customers, especially larger scale utility organizations, have no optics into the health or operation of these systems. For instance, a utility company may have an understanding of the status of a substation but, otherwise (e.g., beyond the substation at homes or businesses), fault detection is performed reactively and/or manually. When a customer reports a problem with their power to a utility provider, the provider would typically dispatch a truck that travels to the customer's location and either wirelessly reads a meter or physically inspects the local hardware. Accordingly, there is significant delay before fixing problems and repair personnel are often dispatched for minor problems or at an incorrect priority.

For more severe or widespread incidents that occur across multiple customers or systems, utility providers will often receive phone calls or reports from local customers that a crises or other issue is occurring, such as where a power line is down, a home is on fire, there is a larger outage, or otherwise. Based on the phone calls, the provider will dispatch repair trucks, which will travel to the fault location to investigate its severity. In some instances, the repair truck (i.e., a human repair person) will request additional repair vehicles to assist with more severe faults.

Furthermore, previous systems used excessively complicated, expensive, and limited hardware for communicating with power sources, batteries, or other systems. Accordingly, these previous technologies failed to provide building, residence, or device level visibility and control, which led to increased safety risks and decreased flexibility.

### SUMMARY

In some aspects, the techniques described herein relate to a system including: an energy storage unit including: a battery storing energy mechanically or chemically; and an inverter coupled with the battery and converting direct current from the battery to alternating current for use by one or more loads; and a control system coupled with one or more power sources, the energy storage unit, and the one or more loads, the control system including: one or more electrical circuits electrically coupling one or more electrical switches that route current between the one or more power sources and the one or more loads, the one or more power sources including the inverter; and a controller communicatively coupled with the inverter and the one or more electrical switches.

In some aspects, the techniques described herein relate to a system, wherein: the one or more electrical circuits electrically couple one or more circuit breakers, one or more power meters, and the one or more electrical switches, the one or more electrical switches including one or more relay switches that switch the one or more power sources between a utility grid and the energy storage unit.

In some aspects, the techniques described herein relate to a system, wherein: the energy storage unit includes a flywheel that mechanically stores energy and provides current to the one or more loads using a motor and the inverter based on local control by the controller, the controller communicating with the inverter and the one or more relay switches to route the current between the energy storage unit and the one or more loads.

In some aspects, the techniques described herein relate to a system, wherein: the controller is communicatively coupled with the inverter and the one or more electrical switches, the controller communicates with the inverter and a remote server to determine a mode and actuates the one or more electrical switches based on the mode to route power from the one or more power sources.

In some aspects, the techniques described herein relate to a system, wherein the controller includes: one or more processors coupled with a first communication port for communicating with the inverter, a second communication port for communicating with a remote server, and one or more electrical ports for actuating the one or more electrical switches.

In some aspects, the techniques described herein relate to a system, wherein: the one or more processors monitor data received from the inverter and a meter, process the monitored data, locally determine a fault, perform a local action based on the fault, and transmit fault data to the remote server.

In some aspects, the techniques described herein relate to a system, wherein: the controller is communicatively coupled with the energy storage unit via a controller area network to monitor a status of the energy storage unit; and the controller is communicatively coupled with the inverter to monitor a status of one or more solar panels.

In some aspects, the techniques described herein relate to a system, wherein: the controller is communicatively coupled with a twelve-volt relay switch that is coupled with one or more of an electrical contactor and a second relay switch, the twelve-volt relay switch being configured to control one or more of the second relay switch and the electrical contactor.

In some aspects, the techniques described herein relate to a system, wherein: the controller is communicatively coupled with a remote server to receive a job from the remote server, and the controller verifies the job against a defined threshold prior to performing a configuration of the system based on the job.

In some aspects, the techniques described herein relate to a system, wherein: the control system is electrically coupled with a utility grid, the one or more loads, and the energy storage unit; the control system includes a central nervous system board, a relay switch controlled by the central nervous system board, and an electrical contactor controlled by the relay switch, the central nervous system board including the controller; and the control system, using the central nervous system board, controls the one or more electrical switches to route power among the utility grid, the one or more loads, and the energy storage unit.

In some aspects, the techniques described herein relate to a system, wherein the central nervous system board includes: an application processor, a first port communicatively coupling the application processor with a smart power meter, a second port communicatively coupling the application processor with the inverter, a third port communicatively coupling the application processor with the one or more electrical switches, and a fourth port communicatively coupling the application processor with a remote server.

In some aspects, the techniques described herein relate to a system, wherein the controller includes: the controller is coupled with a utility grid power source via an electrical contactor, the electrical contactor switching current between the utility grid power source and the inverter.

In some aspects, the techniques described herein relate to a control system, wherein: the electrical contactor is electrically coupled with the inverter via an electrical relay switch.

In some aspects, the techniques described herein relate to a system, wherein: the controller controls one or more of the electrical contractor and the electrical relay switch via a second electrical relay switch.

In some aspects, the techniques described herein relate to a system including: an energy storage unit including: a battery storing energy mechanically or chemically; and an inverter coupled with the battery and converting direct current from the battery to alternating current for use by one or more loads; and a control system coupled with one or more power sources, the energy storage unit, and the one or more loads, the control system including: one or more electrical circuits including a first relay switch coupled with a second relay switch and an electrical contactor, the electrical contactor switchably coupling a utility grid power source with the one or more loads, the electrical contactor being electrically coupled with a first relay switch, the first relay switch being coupled with the energy storage unit, the second relay switch being coupled with one or more of the first relay switch and the electrical contactor; and a controller communicatively coupled with the inverter and the second relay switch, the controller including a processor and a memory storing instructions that cause the controller to actuate the second relay switch.

In some aspects, the techniques described herein relate to a system, wherein: the controller is communicatively coupled with a remote server to determine a mode and actuates the second relay switch based on the mode to route power from the one or more power sources.

In some aspects, the techniques described herein relate to a system, wherein the controller includes: one or more processors coupled with a first communication port for communicating with the inverter, a second communication port for communicating with a remote server, and one or more electrical ports for actuating the second relay switch.

In some aspects, the techniques described herein relate to a system, wherein: the processor monitors data received from the inverter and a meter, process the monitored data, locally determine a fault, perform a local action based on the fault, and transmit fault data to the remote server.

In some aspects, the techniques described herein relate to a method including: receiving, by a processor, a message from a remote server indicating an instruction for setting a mode of a control system, the control system routing current to an electrical system of a building from one or more of an energy storage unit and an electrical utility grid, wherein: the energy storage unit includes: a battery storing energy mechanically or chemically; and an inverter coupled with the battery and converting direct current from the battery to alternating current for use by one or more loads; and the control system is coupled with the energy storage unit, the electrical utility grid, and the electrical system of the building, the control system including: one or more electrical circuits electrically coupling one or more electrical switches that route current from the one or more of the energy storage unit and the electrical utility grid based on the mode; and a controller communicatively coupled with the inverter and the one or more electrical switches, the controller including the processor, the controller being communicatively coupled with the remote server; setting, by the processor, the mode of the control system by actuating the one or more electrical switches; and transmitting, by the processor, a status message based on the status of the control system to the remote server.

Other implementations of one or more of these aspects or other aspects include corresponding systems, apparatus, and computer programs, configured to perform the various actions and/or store various data described in association with these aspects. These and other implementations, such as various data structures, are encoded on tangible computer storage devices. Numerous additional features may, in some cases, be included in these and various other implementations, as discussed throughout this disclosure. It should be understood that the language used in the present disclosure has been principally selected for readability and instructional purposes, and not to limit the scope of the subject matter disclosed herein.

### BRIEF DESCRIPTION OF THE DRAWINGS

This disclosure is illustrated by way of example, and not by way of limitation in the figures of the accompanying drawings in which like reference numerals are used to refer to similar elements.

FIG. 1 is a block diagram of an example energy as a service platform.

FIG. 2 is a block diagram showing example components of, and the interaction between components of the energy as a service platform.

FIGS. 3A and 3B illustrate example energy storage unit assemblies.

FIGS. 4A and 4B illustrate example network configurations of components for monitoring, analyzing, and addressing faults across one or more energy storage devices.

FIG. 5 is an example flowchart depicting a fault categorization decision tree for classifying faults.

FIG. 6 illustrates a flowchart depicting an example alert and action processing flow.

FIGS. 7A-7C illustrate example graphical user interfaces showing example alerts and associated event details.

FIGS. 8A-8C illustrate example interfaces in which faults are identified for one or more energy storage units.

FIGS. 9A and 9B illustrate graphical interfaces showing health telemetry data across one or more energy storage units.

FIG. 10 illustrates an example graphical user interface in which various event monitors are listed.

FIGS. 11A-11F illustrate example graphical user interfaces showing energy storage unit analytics and data.

FIGS. 12A and 12B illustrate example environments in which the central nervous system may be used, such as its local and remote connections.

FIGS. 13A and 13B illustrate an example board diagram of a central nervous system board.

FIGS. 14A and 14B illustrate a block diagram of an example command-and-control assembly and system context.

FIG. 15 illustrates a block diagram of an example implementation of a command-and-control system.

FIG. 16 illustrates a block diagram of an example implementation of a command-and-control system and context.

FIG. 17 illustrates a state machine diagram showing an example state machine that may be used with a central nervous system and/or command-and-control assembly.

### DETAILED DESCRIPTION

This description includes several improvements over previous solutions, such as those described in reference to the Background. Systems and methods are described for providing an energy emergency response framework in which events in energy production, storage, and use are detected and a response is automatically generated depending on the event's context, such as addressing faults in local power production or storage devices, which may be at residences, businesses, electric vehicle charging stations, or otherwise.

Some implementations of the technology additionally or alternatively include an energy storage unit central nervous system, which may provide command and control functionality for one or more energy storage units, such as by controlling one or more inverters, receiving sensor data from one or more sensors, communicating with external servers, or performing other operations, such as the example operations for the energy emergency response framework described herein.

The example central nervous system (CNS) described herein may include a control module that collects certain information, interacts with certain components, and issues certain commands. It may be custom designed for an energy storage unit, such as a mechanical (e.g., a flywheel) and/or chemical (e.g., a chemical battery) energy storage unit. Implementations of the CNS may be used to provide an emergency response framework, as described in the examples herein. Additionally, or alternatively, implementations of the CNS may communicate with and/or control other systems (e.g., inverters, web servers, sensors, equipment controllers, or other devices) in order to integrate an energy storage unit with an electric vehicle charger/EVSE, an LED status ring, or other devices and services. For example, the CNS may be communicatively coupled with one or more automated or manual devices, such as an EVSE, a mechanical, electrical, or chemical battery, various loads, etc.

The CNS may be coupled with and control one or more inverters (e.g., in the same or different cabinet) of different sizes or configurations, as described below. The CNS may instruct the inverter(s) to receive power from an electrical grid or other power source, provide power to a motor coupled with a flywheel, receive power from the motor, provide or receive power to a chemical battery, or perform other operations. For example, as described in further detail below, the CNS may receive instructions from a server and, based on the instructions, set a certain mode, such as self-consume, battery priority, storm watch, off-grid, away, grid share, grid stabilize, EV charging, or otherwise.

The CNS may have various hardware components that are unique to its application and provide significant benefits over those of previous systems. For instance, its hardware, architecture, switches, inputs, outputs, logic, and other features allow it to be built in larger quantities and for cheaper than other solutions. The CNS also provides visibility that allows command, control, and understanding of the loads, storage, and energy sources (e.g., across one or more energy storage units and locations) to electrical utilities, customers, flywheel manufacturers, or other stakeholders. Accordingly, stakeholders, either manually or automatically, may view information and/or control how components coupled with the energy storage unit (ESU) are used, their health, and otherwise. For instance, while previous systems did not allow electrical utility companies to have visibility into health, faults, or status of systems below a sub-station level, the technologies herein allow pro-active management and alerting, which increases safety, efficiency, and reliability.

In some implementations, one, two, or more mechanical-energy storage units may be installed at a residence to provide backup power in case of a power outage, to store electricity generated using residential solar panels, or to offset unevenness of power production and usage (e.g., electrical storage at a residence may be controlled to address the unevenness at the residence, nearby residences, or across the power grid). A mechanical-energy storage unit may be buried or mounted next to an electrical panel or placed in a shed outside a residence, placed in a garage or utility room, or stored offsite.

In some implementations, multiple mechanical-energy storage units may be coupled together at the same or distinct locations to scale energy backup at a larger facility, such as a business, or by an electrical utility. For instance, many mechanical-energy storage units may be placed at a facility, whether buried or above ground for use by the facility or by an electrical utility provider. The multiple mechanical-energy storage units may include or be coupled to MESU (mechanical energy storage unit) control units that may be communicatively linked to each other or to a central server to control storage and distribution of the stored energy (e.g., by controlling the rotational frequency of a flywheel to keep various flywheels at efficient speeds).

In some implementations, the energy storage unit (ESU) may be based on a flywheel, chemical battery, supercapacitor, etc., as described in further detail in reference to the figures herein.

The technology described herein can provide monitoring, analysis, troubleshooting, and/or alerting on a local, individual (e.g., a single ESU) level and/or end to end across single, multiple, clusters, or an entire network or energy ecosystem of energy storage units. The technology may provide second-by-second monitoring and alerting in which faults are categorized and automatically addressed where possible, tiered by severity (e.g., alpha, bravo, charlie, delta, echo, etc.). Where the technology determines that a fault requires action that cannot be automatedly addressed locally, it may automatically digitally trigger, using firmware on a local device (e.g., by firmware operating on a controller of an ESU) a human or other external response, which trigger message may include triage/severity information. As faults can be automatically identified, response time is shortened, uptime is improved, and safety is increased. Example energy storage units (ESU) may also be referred to herein as mechanical energy storage units (MESU) or flywheel energy storage system (FESS), though various implementations and types may be used.

The technology allows rapid, continuous monitoring of local hardware (e.g., a flywheel or battery), which may be addressed, analyzed, and/or categorized on an individual level and/or across multiple devices. For instance, the system and method may determine the generation, use, and storage of each ESU (e.g., at a specific house) or cluster of ESUs (e.g., a group of flywheels at one or more locations), potentially down to the circuit level. These and other features may be provided using the technologies described in further detail below.

As data is sampled from various sources and/or sensors at a device, the controller or other computing device may perform operations described below to perform operations locally at an ESU or escalate it, as determined. Alert messages generated by the local system may be processed on the cloud either independently or in conjunction with the local device (e.g., the ESU), as described below.

For example, a mechanical or chemical battery power storage system may have various devices and sensors that generate data that identify faults either independently or as combinations. For instance, the CNS (central nervous system, controller, inverter computing device, etc.) may receive and process the data to identify faults and/or perform other operations, as described in further detail below. For example, as described elsewhere herein, the CNS may take local action on faults determined from an inverter, mechanical battery, and/or chemical battery. In some instances, an ESU/FESS central processing unit (CPU) integrated with or coupled with the CNS may take local action on ESU faults. The CNS may be used to escalate and alert (e.g., a remote server) on ESU faults when the faults cannot be handled by the ESU CPU (e.g., so that a service professional may be dispatched to the location of the energy storage unit that generated the fault message). It should be noted that although the CNS is described herein as being located adjacent to the ESU, it may be located remotely (e.g., in a different geographic location). In some implementations, depending on the fault, the CNS may take local action to address a fault and/or may transmit an alert message to a server, which processes the fault/alert message(s) and perform other operations, such as bucketizing and/or triaging, issuing commands to the ESU/CNS, or dispatching repair personnel based on the fault, alert, bucket, severity level, etc. In some implementations, as noted below, the data for multiple devices may be combined and analyzed for a cluster, arrangement, geographic area, etc., to determine systemic issues.

Example implementations of the CNS are described in further detail below, such as in reference to its hardware, layout, architecture, etc.

Example data and sensors that are monitored for a local energy storage and/or production device may include temperature, accelerometer, rotation, gyroscopic, orientation, voltage, current, state of charge, or otherwise for one or more components of the system, such as the CNS, inverter, meter, flywheel, chemical battery, supercapacitor, solar system, wind turbine, etc. In some implementations, the CNS may also be coupled with external sensors, such as weather stations, etc., which it may use in detecting or categorizing an event. The CNS may aggregate the signals and detect outliers that, by themselves, over a defined time period, or in combination with other data/signals indicate a fault.

For example, the CNS may determine that there is a high voltage alert with the local system indicating a voltage higher than the system is designed to handle. The CNS may determine that a fault has been detected, generate a message describing the fault, and send the message to a server where it is processed to determine severity and further actions. In some instances, the CNS may take local actions, such as spinning down a flywheel, discharging a battery, shutting down an inverter, or other actions, such as those described elsewhere herein. It should be noted that, as indicated elsewhere herein, a FESS or other ESU may include a separate CPU or hardware controller coupled with the CNS, which is configured to perform these or other functions, such as by spinning down the flywheel and notifying the CNS of the action taken.

In another example, a CNS may detect a battery having a temperature beyond a defined threshold. The CNS (and/or a FESS CPU coupled with the CNS, as noted elsewhere herein) may determine, for instance, based on the relative temperature, a severity level and take remedial action, such as shutting down the device, decreasing flywheel velocity, etc., in addition or alternative to sending the fault message. For example, the CNS may locally detect excessive battery temperature, power down the system, and transmit a fault message rather than waiting for a server response to do so. The CNS or server may elevate a fault severity level, classification, or otherwise flag it if multiple or certain alerts come in at the same time, as noted below.

The faults or events can be digitally triaged by the server to generate an alert and, based on the severity level of the alert, the server (e.g., directly or in conjunction with another service), may dispatch a repair team/vehicle based on the fault/alert, etc. Furthermore, if a certain alert level has been reached for certain faults, the server may automatically take other actions, such as automatically transmitting a message that causes emergency services to be dispatched to the location corresponding to the fault. For instance, if a certain battery temperature (e.g., over 500 degrees Celsius) is detected, the technology may determine that a fire or explosion is occurring or imminent and may communicate with a local fire department to dispatch a fire truck and/or take other measures.

In some implementations, if a customer that owns the ESU is traveling, the CNS and/or server may look at the thermal runaway of a battery and digitally triage it, dispatch a repair truck, and/or automatically dispatch fire and/or emergency medical services to the location even without the customer providing any interaction.

Fault messages may be processed both locally and on a separate device, such as one or more cloud servers or services, and the fault messages may include information identifying the specific fault, such as sensor information, timing, location, specific battery, flywheel, or other component data, etc. Accordingly, in associating individual data or faults with individual local devices (e.g., devices at one or more different residences), the server may localize a problem to a specific component, specific MESU, specific residence or location, specific cluster of MESUs, etc. For instance, the server may determine that multiple MESUs in a cluster are reporting the same faults and may, therefore, identify a larger issue or a higher priority alert.

Due to the local and remote processing, as well as the other features described herein, the architecture is highly scalable to grow organically, for instance, as additional devices are added to a location or cluster, or as a provider monitors increasing quantities of devices. Accordingly, the provider can gain insight into local devices and circuits in ways that were not previously possible. For example, where ESUs are located at individual residences, individual residences can be monitored (e.g., by a customer or a provider), clusters of residences, subdivisions, etc., can be monitored either locally, at a subdivision/cluster level, or by a utility or provider.

Where faults in a certain device could affect other devices coupled therewith (e.g., in a cluster of MESUs), the system may automatically adjust the faulty device to protect the other devices, adjust the other devices to balance load, or otherwise. Similarly, where a systemic fault is detected across multiple devices, the system may elevate the issue and provide real-time, accurate data, so that the correct type or quantity of repair trucks may be dispatched to the correct locations, rather than necessarily having to dispatch a first truck to investigate and an additional truck when a more severe issue is determined by the dispatched engineer.

Additionally, as additional devices are monitored, machine learning models can be used across the devices to improve accuracy of fault detection, for instance, by using supervised machine learning to adjust weights for both fault detection and categorization.

It should be noted that while certain features are summarized here, and in the figures, other features are possible and contemplated herein.

With reference to the figures, reference numbers may be used to refer to components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components.

The innovative energy technology disclosed in this document provides novel advantages including the ability to integrate modern technology with conventional power infrastructure; enable rapid transition to renewable energy sources; provide backup to the power grid, use the power grid as a backup; store power locally in nodes and regionalized storage clusters of nodes; isolate and minimize the impact of power outages; whether caused by natural disasters, infrastructure failure, or other factors; provide affordable alternatives to expensive and environmentally unfriendly electrochemical batteries; provide consumers the option to be independent from carbon-based power sources; and decentralize electric power production.

The innovative energy technology disclosed in this document provides novel advantages including the ability to integrate modern technology with conventional power infrastructure; enable rapid transition to renewable energy sources; use the power grid as a backup; store power locally in nodes and regionalized storage clusters of node(s); isolate and minimize the impact of power outages; whether caused by natural disasters, infrastructure failure, or other factors; provide affordable alternatives to expensive and environmentally unfriendly electrochemical batteries; provide consumers the option to be independent from carbon-based power sources; and decentralize electric power production.

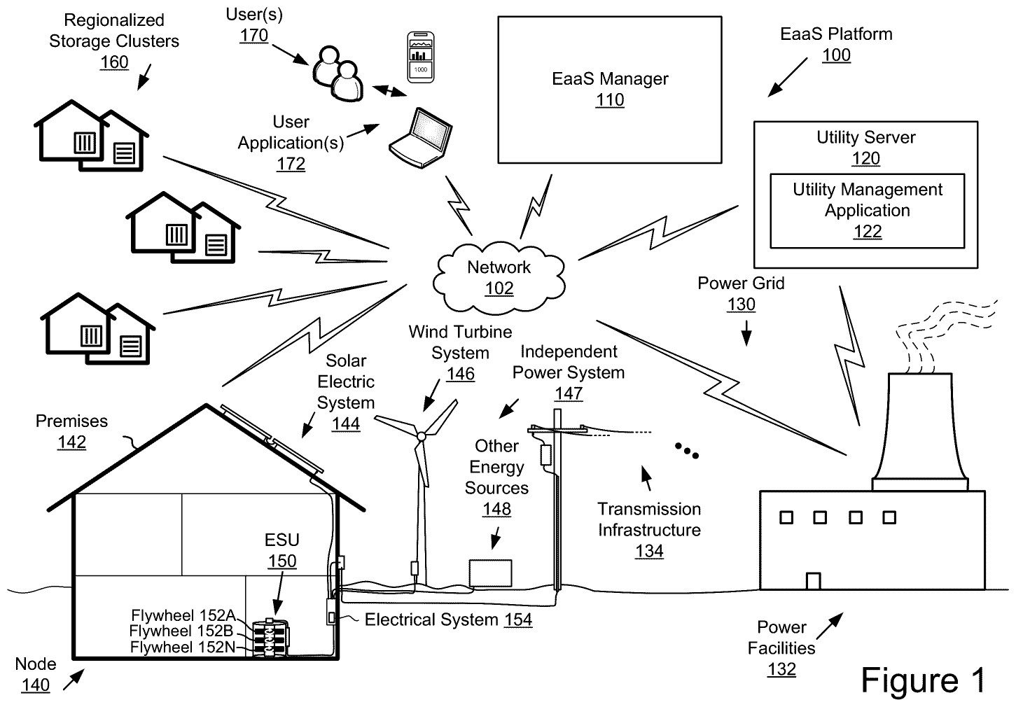

As depicted in FIG. 1, the innovative energy technology described herein may comprise an energy as a service platform (EaaS platform) 100. The EaaS platform 100 may include an EaaS manager 110, one or more continuous detection and response (CDR) servers 116, user application(s) 172 operable on computing devices accessible to and interactable by user(s) 170 of the EaaS platform 100 and configured to send or receive data to the EaaS manager 110, regionalized storage clusters 160 comprised of one or more nodes 140, and the power grid 130 that comprises one or more power facilities 132 that are connected to a power transmission infrastructure 134.

A node 140 may be comprised of a power consuming entity and at least one ESU (e.g., an ESU 150 with a flywheel 152 is provided as an example, although chemical, etc., batteries may be used in addition to or alternative to the flywheel(s) 152, such as the example ESU 402 described below). A node 140 may be an entity that either consumes power itself or is coupled to entities that consume power. In FIG. 1, a node 140 is depicted as a premises 142, such as a residential home, but it should be understood that any entity that consumes power is applicable, such as one or more appliances, a commercial structure such as a warehouse or office building, an electronic device or system (whether configured to move or static), a transportation system and/or vehicle, a transportation charging system, a power supply, a power substation, a power substation backup, etc. A regionalized storage cluster may include two or more nodes 140 in a given geographical region. A storage cluster may provide power banking functionality, as discussed further herein. The elements of the node 140 including the MESU(s) 150, the independent power system 147, the power grid 130, and/or any appliances and/or other entities, may be electrically coupled via an electrical system 154 including wiring, junctions, switches, plugs, breakers, transformers, inverters, controllers, and any other suitable electrical componentry.

In the depicted example, a node 140 is equipped with or coupled to power generating technology, such as an independent power system 147 and/or the power grid 130. The independent power system 147 may comprise power generating technology that is localized and that allows for independent power generation, such as renewable power generating technology. Non-limiting examples include a solar electric system 144 (comprising a solar array, controllers, inverters, etc.), a wind turbine system 146 (comprising turbine(s), controllers, inverters, etc.), and/or other energy sources 148, such as hydropower, geothermal, nuclear, systems and their constituent components, etc. The power generating technology may additionally or alternatively be conventional carbon-based power generating technology such as the depicted power grid 130, although for carbon negative or neutral implementation, a greener power generating technology may be preferred.

The node 140 may include or be coupled to an energy storage unit that is capable of storing excess power that is produced by the power generating technology. In some implementations, the energy storage unit may comprise a mechanical-energy storage unit (MESU) 150. The MESU 150 includes one or more flywheels 152A, 152B . . . 152N (also simply referred to individually or collectively as 152). The MESU's 150 convert the electricity received from the power generating technology to kinetic energy by spinning up (increasing the spin rate) of the flywheels 152.

Each flywheel 152 may be configured to store up to a certain maximum amount of energy. By way of non-limiting example, a motor 310 coupled to the flywheel 152 may be configured to spin the flywheel 152 up to between 15,000 rotations per minute (RPM) and 25,000 RPM, such that the flywheel 152 may store between 18 kilowatt hours (kWh) and 28 kWh of electricity. Combined, three stacked flywheels 152 could store between 54 kWh and 84 kWh of power. During hours in which the power generation technology, such as the solar cells, produce less power than what is consumed by the electrical apparatuses (e.g., appliances) of the premises 142, the motor 310 may be operated as a generator that converts the kinetic (mechanical) energy stored in the flywheel 152 to electricity, thereby pulling power from the flywheel 152 to meet the local power needs of the node 140 (e.g., power the electrical apparatuses of the premises 142). In this example, advantageously the node 140 may use an average of 15 kWh of power daily and the MESU 150 is capable of powering the node 140 fully for about 4-6 days should the local power generating cease to produce any power. It should be noted that these speeds and capacities are provided by way of example and that other implementations are possible and contemplated herein.

In another example, as discussed further elsewhere herein, a utility may be integrated with the EaaS manager 110 and its utility management application 122 signal the power management application 111 via the node APIs 113 that it is experiencing a surge in demand for power, and the power management application 111 may signal a node 140 or cluster of nodes 140 (e.g., storage cluster 160) to spin off power from the flywheels 152 and provide the energy back to the grid through the transmission infrastructure 134, which may be connected to the node(s) 140 through connection points (e.g., two or three phase electrical service drops or buried power lines connected to a service panel, which typically includes power meter(s)). Conversely, the utility may be producing excess power and may wish to bank/store the power. The utility management application 122 may signal the power management application 111 via the node APIs 113 that it needs to store a given amount of power, and the power management application 111 may in turn signal a node 140 or cluster(s) of node(s) 140, such as one or more regionalized storage clusters 160 to inform them of the storage need, and node(s) 140 in those storage cluster(s) 160 that have excess capacity and are configured to receive power from the grid may receive the power through the transmission infrastructure 134 and store it as mechanical energy in the MESUs for later retrieval. The EaaS platform 100 may charge the utility for the power banking service, as discussed further elsewhere herein.

It should be understood that the RPMs and kWh figures provided in the herein are meant as non-limiting examples and that the MESU's 150 may be configured with flywheels 152 that are capable of storing more or less power depending on the implementation. For example, the weight of the flywheels 152, the materials used for the flywheels 152, the size and configuration of the flywheels 152, the efficiency of the motor 310 and bearings, and so forth, may all be adjusted based on the use case to provide a desired amount of back-up power for the node 140. By way of further example, a flywheel 152 may be made of steel, aluminum, carbon fiber, titanium, any suitable alloy, and/or any other material that is capable of handling the cycles, vibration, radial and sheer stress and strain, and other conditions to which such a flywheel 152 would be subjected.

The power transmission infrastructure 134 comprises a power network that couples power-consuming entities, such as homes, offices, appliances, etc., to power facilities that generate power from carbon, nuclear, and/or natural sources. The transmission infrastructure 134 may include intervening elements, such as step-up transformers, substations, transmission lines, and so forth, which are interconnected to provide power widely to different geographical regions.

A power utility (also simply referred to as a utility), which may own and operate one or more power facilities and portions of the transmission infrastructure 134, may operate a utility server configured to execute a utility management application 122. The utility management application 122 may perform various functions such as load balancing, load managing, and grid energy storage, to manage the supply of electricity based on real-time demand. However, given the limitations of existing grid technologies, power outages, brownouts, and expensive peak power costs are still the norm.

A user may use an instance of a user application 172 executing on a computing device, such as the user's mobile phone or personal computer, to configure and interact with the MESU(s) 150 that they are authorized to control, such as a MESU 150 installed at their home or business, as discussed further elsewhere herein.

As shown in FIG. 1, the EaaS manager 110, the utility server 120, the power facilities 132, elements of the power grid 130, the wind turbine system 146, the solar electric system 144, the other sources 148, the node(s) 140, the regionalized storage clusters 160, the user applications 172 and associated computing devices, etc., may be coupled for communication and connected to the network 102 via wireless or wired connections (using network interfaces associated with the computing devices of the foregoing elements). The network 102 may include any number of networks and/or network types. For example, the network 102 may include one or more local area networks (LANs), wide area networks (WANs) (e.g., the Internet), virtual private networks (VPNs), wireless wide area network (WWANs), WiMAX® networks, personal area networks (PANs) (e.g., Bluetooth® communication networks), various combinations thereof, etc. These private and/or public networks may have any number of configurations and/or topologies, and data may be transmitted via the networks using a variety of different communication protocols including, for example, various Internet layer, transport layer, or application layer protocols. For example, data may be transmitted via the networks using TCP/IP, UDP, TCP, HTTP, HTTPS, DASH, RTSP, RTP, RTCP, VOIP, FTP, WS, WAP, SMS, MMS, XMS, IMAP, SMTP, POP, WebDAV, or other known protocols.

The EaaS manager 110, the CDR server(s) 116, the utility server 120, the node(s) 140, the power facilities, and the user devices may have computer processors, memory, and other elements providing them with non-transitory data processing, storing, and communication capabilities. For example, each of the foregoing elements may include one or more hardware servers, server arrays, storage devices, network interfaces, and/or other computing elements, etc. In some implementations, one or more of the foregoing elements may include one or more virtual servers, which operate in a host server environment. Other variations are also possible and contemplated.

The continuous detection and response (CDR) server(s) 116 may include one or more computing device external to a node 140, which may be used to provide event detection and response, such as is described in further detail throughout this disclosure. For instance, a node 140 may include a central nervous system (CNS) 412 that operates on the node 140, which may also run the flywheel controller 254 and/or node application 240, although other implementations are possible and contemplated herein. The CDR server(s) 116 may include one or more remote computing devices or servers that provide analysis, reporting, or other services, such as those described in further detail herein.

Depending on the implementation, the CDR server(s) 116 may be integrated with the EaaS manager 110 and/or the utility server 120, although it should be noted that other implementations are possible and contemplated herein.

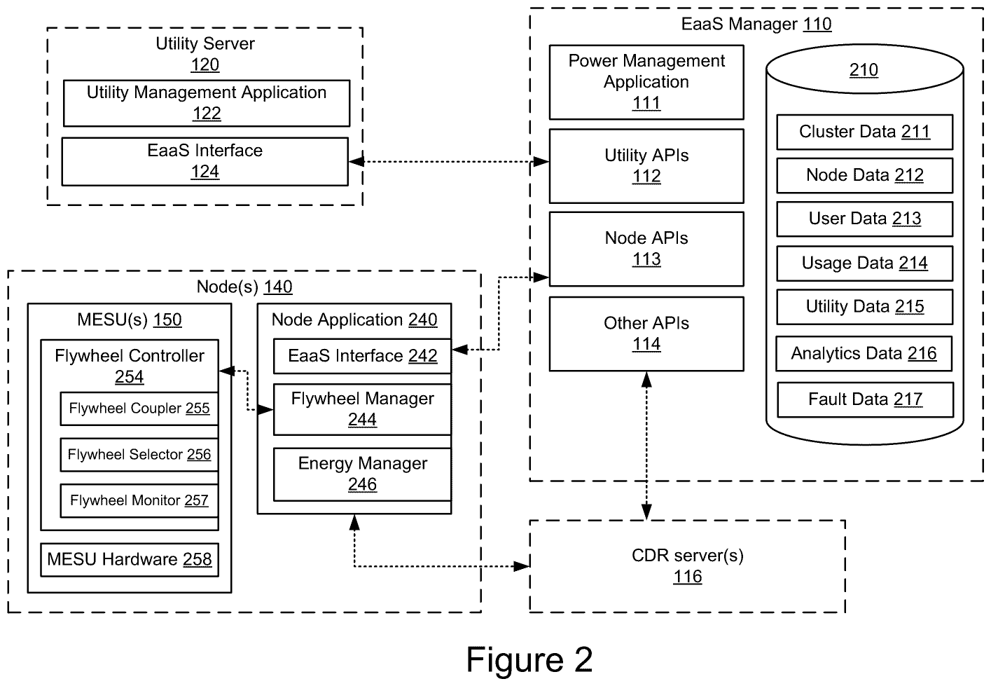

It should be understood that the EaaS platform 100 illustrated in FIG. 1 and the diagram illustrated in FIG. 2 are representative of example systems and that a variety of different system environments and configurations are contemplated and are within the scope of the present disclosure. For example, various acts and/or functionality may be moved between entities (e.g., from a server to a client, or vice versa, between servers, data may be consolidated into a single data store or further segmented into additional data stores, and some implementations may include additional or fewer computing devices, services, and/or networks, and may implement various functionality client or server-side. Further, various entities of the system may be integrated into a single computing device or system or divided into additional computing devices or systems, etc., without departing from the scope of this disclosure.

FIG. 2 depicts a block diagram showing example components of, and the interaction between, the utility server 120, the node(s) 140, the CDR server(s) 116, and/or the EaaS manager 110. The utility server includes an instance of the utility management application 122 and an EaaS interface 124. The EaaS manager 110 includes a power management application 111, utility APIs 112, node APIs 113, other APIs 114, and a data store 210. The data store 210 may store and provide access to data related to the EaaS platform 100, such as cluster data 211, node data 212, user data 213, usage data 214, utility data 215, analytics data 216, and fault data 217.

A node 140 may include one or more ESU(s) 150 or 402, including the chemical or other forms of electrical storage that are discussed herein, although a MESU 150 is provided as an example.

A MESU 150 may include an instance of a flywheel controller 254, which may be or include a central nervous system (e.g., the CNS 412 described elsewhere herein). For instance, the CNS 412 may run or execute the flywheel controller 254 and its components, and the node application 240 and its components. In some implementations, the flywheel controller 254 may include a flywheel coupler 255, a flywheel selector 256, and flywheel monitor 257. The MESU hardware 258 may comprise a chassis, one or more flywheels 152, magnets and/or bearings, a flywheel coupler 255, and/or a motor-generator (e.g., the motor 310 referenced below). The motor-generator may be coupled to each flywheel 152 via a flywheel coupler 255. The flywheel coupler 255 may engage and disengage the motor-generator from the flywheel 152, such that each flywheel 152 may spin freely when disengaged and may be coupled to the motor-generator when engaged such that the motor-generator may increase the speed of the flywheel 152 (spin up the flywheel 152), or the flywheel 152 may spin the generator to produce power. Each flywheel 152 may be levitated using magnets to minimize the friction caused by the rotation of flywheel 152. As an example, a maglev unit may be used to suspend and retain the flywheel 152 while spinning.

Additionally, or alternatively, bearings, such as but not limited to ceramic bearings, may be used to support and retain the flywheel 152 while spinning. The chassis may house and support the flywheels 152. flywheels 152 may be arranged horizontally or vertically. In horizontal orientation, flywheels 152 may have a wheel-like shape and may be stackable one on another in the same chassis, but still configured to spin independently of one another. In such a configuration, the coupler may couple to each flywheel 152 independently, or more than one coupler and motor 310 may be used, depending on the implementation. In a vertical orientation, the flywheels 152 may have a roll-like shape, and may be positioned parallel to one another in the chassis. In either orientation, in some implementations, the chassis may include a housing that encloses the MESU 150 and provides a vacuum environment in which the components of the MESU 150 may operate. This is advantageous as it may seal out dirt, debris, and corrosion causing elements, and allow for the flywheels 152 and other components to optimally operate.

In some implementations, a node 140 may include one or more controllers, such as the flywheel controller 254 or CNS 412, or other computing devices that may receive and process information from the EaaS manager 110 and/or CDR server(s) 116 for the two or more MESU(s) 150, and may send signals to the MESU(s) 150 (e.g., via the flywheel controller 254 and/or MESU hardware 258) and receive and process signals from the MESU(s) 150 (e.g., via the flywheel controller 254 and/or MESU hardware 258), to control the functionality and operations of the MESU(s). In some further implementations, the structure, acts, and/or functionality of the flywheel controller 254 and the node application 240 and their constituent components may be combined, and the node 140 may represent a MESU(s) 150 itself, to which one or more appliances that consume power may be coupled to receive power. Other variations are also possible and contemplated.

For example, in some implementations, the some or all of the CDR server(s) 116 or the components or services thereof may be integrated with the EaaS manager 110 or utility server 120 (e.g., and/or the EaaS manager 110 and/or utility server 120 may be CDR server(s) 116). The CDR server(s) 116 may be one or more separate computing devices or servers that may be located remotely from one or more of the node(s) 140, the EaaS manager 110, and/or utility server 120. Depending on the implementation, the CDR server(s) 116 may communicate directly with the node(s) 140 (e.g., with a flywheel controller 254, node application 240, or CNS 412) or may communicate with the EaaS manager 110 to communicate with the node(s) 140 (e.g., where the EaaS manager 110 acts as an intermediary between the node(s) 140 and the one or more of the CDR server(s) 116. For instance, the CDR server(s) may communicate with the EaaS manager 110 (e.g., via the other APIs 114) to receive node data 212, determine user data 213, determine fault data 217, store fault data 217 (e.g., store events, faults, or alerts), or perform other operations.

The utility management application 122, CDR server(s) 116, CNS 412, flywheel controller 254, node application, node management application, utility APIs, node APIs, MESU APIs, and/or other devices may each include hardware and/or software (e.g., stored in computer readable memory) executable on one or more processors to provide the acts and functionality disclosed herein.

Specifically, the utility management application 122 may be executable by the utility server 120 to monitor power generation and distribution by one or more power facilities and a transmission infrastructure 134. The utility management application 122 may receive signals from various entities of the EaaS platform, such as the EaaS manager 110, the nodes, the transmission infrastructure 134, other utility management applications associated with other providers, and so forth. The utility management application 122 may communicate via the EaaS interface 124 with the EaaS manager 110 to access the services provided by the EaaS manager 110. In particular, the EaaS interface 124 may interact with the utility APIs of the EaaS manager 110 to request power banking, request the provision of supplemental power, to provide usage, performance, and/or demand data, and so forth. In some implementations, the EaaS interface 124 may generate and transmit a secure request via the network to the utility APIs. The power management application 111 may receive the request via the utility APIs and process it accordingly.

The power management application 111 may be coupled to the data store 210 to store and retrieve data. The data stored by the data store 210 may be organized and queried using any type of data stored in the data store (e.g., cluster ID, user ID, utility ID, node ID, MESU ID, configuration data, etc.). The data store 210 may include file systems, databases, data tables, documents, or other organized collections of data.

Cluster data 211 may comprise information about a cluster of two or more nodes (e.g., regionalized storage cluster), such as the identity of the node(s) 140, the storage capacity of the storage cluster 160, the availability of the storage cluster 160, the operational health of the storage cluster 160 and/or constituent MESU(s) 150, the historical performance of the storage cluster 160, etc.).

Node data 212 may comprise information about a node, such as the number of MESUs installed at the node 140, the type of node 140, the operational health of the MESU(s) 150, any restrictions or operation parameters of the MESU(s) 150, configuration data for the MESU(s) 150, identifiers of the MESU(s) 150, who the MESU(s) 150 belong to, whether the MESU(s) 150 can be used for banking grid power, whether the MESU(s) 150 have been inactivated, and so forth.

User data 213 may comprise information about the user associated with a storage cluster 160, node 140 or MESU 150, including user account information, login information, user preferences governing the MESUs (e.g., schedule data, activation/inactivation data, etc.).

Usage data 214 may comprise information about the usage of the clusters and/or MESU(s) 150, such as spin rates of the flywheels 152, power output levels, maintenance periods, downtime, inactive periods, third-party use (e.g., use by utilities or neighboring nodes 140), etc.

Utility data 215 may comprise information about utilities that have partnered with the EaaS platform 100, such as utility account information, utility capability information, power banking requirements, contractual parameters, performance requirements, power grid 130 specifications, etc.

Analytics data 216 may comprise insights about the EaaS platform 100, such as local vs. grid power generation, aggregate usage data, aggregate performance data, etc. It should be understood that any other data that would be suitable and applicable to the EaaS platform 100 may be stored and processed by the EaaS manager 110.

Fault data 217 may comprise event data describing events on the node(s) 140, such as any event generated by a battery, flywheel, inverter, sensor data from sensors, or other MESU hardware 258. The event data may include metadata describing a source of the event data, location, timestamps, concurrent data, etc. The event data may describe events, flag or tags on events, whether an event includes a fault (e.g., whether a value of an event data point satisfies a threshold or other defined quantity), whether an event is classified as an alert, thresholds against which data is compared to detect faults, and other data. For instance, fault data 217 may include any of the data described below in reference to the methods and graphical user interfaces, such as sensor data, voltages, state of charge, etc.

The node application 240 and the flywheel controller 254 may communicate with the EaaS manager 110 via the EaaS interface 242, which is configured to interact with the node APIs 113 surfaced by the EaaS manager 110. The node APIs 113 provide methods for accessing data relevant to the node 140 and the MESU(s) 150 associated with the node 140, and executing various functionality, such as signaling unavailability/availability for banking power, requesting a functional upgrade, such as a higher spin rate for one or more flywheels 152 or deactivating/activating a previously active/inactive flywheel 152, reporting usage data and/or state information, and so forth.

The flywheel manager 244 of the node application 240 may be configured to communicate with the flywheel controller 254 to provide operational control signals, such as power banking signals, power extraction signals, spin rate adjustment signals, flywheel enablement/disablement signals, and so forth. The energy manager 246 is configured to communicate with the flywheel manager 244 and provides controls signals to the flywheel manager depending on the energy requirements (produce energy for local use, produce energy for utility use, bank local energy, bank utility-provided energy, etc.).

The flywheel coupler 255 may be configured to control the mechanical coupling of the flywheels 152 with the motor-generator 310, the flywheel selector 256 is configured to select which flywheels 152 to control based on the received control signals, and the flywheel monitor 257 monitors the state of each flywheel 152 for safe operation and performance within defined operational parameters, and can take control of the functionality of the MESU hardware 258 and shut down, slow, suspend, adjust, optimize, or other control the MESU hardware 258 depending on the monitored state.

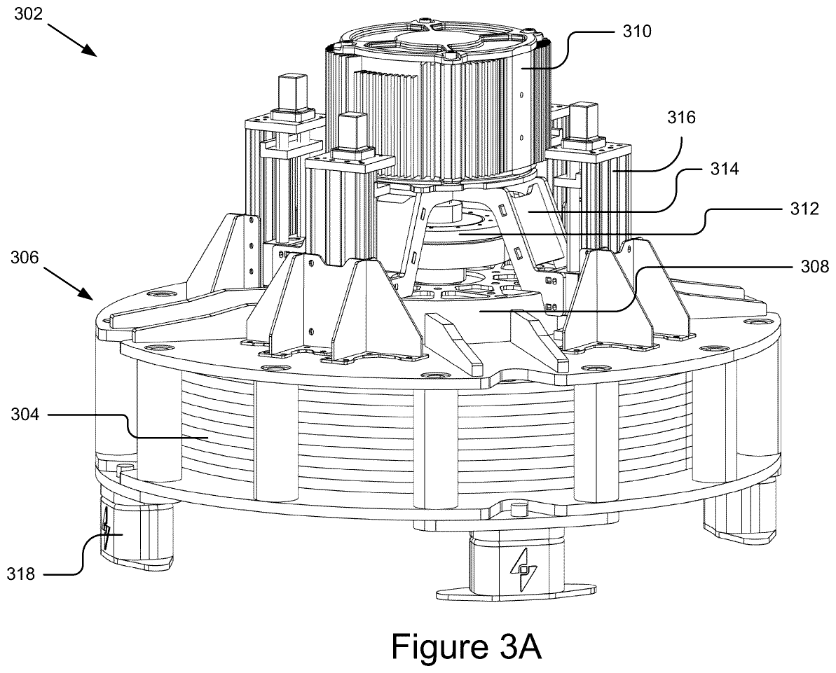

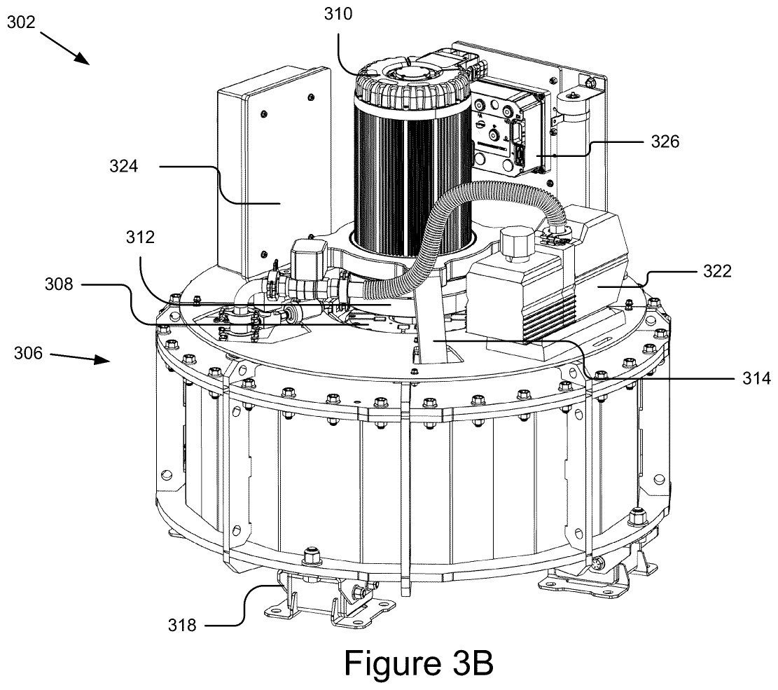

FIGS. 3A and 3B illustrate example implementations of a mechanical-energy storage unit (MESU) assembly 302 that may use a flywheel 304 to store energy using rotational momentum. FIG. 3A illustrates a perspective view of an example MESU assembly 302 with an open housing 306 to expose a flywheel 304. FIG. 3B illustrates a perspective view of an example MESU assembly 302 with an enclosed housing 306. FIG. 3B also illustrates various components, such as a supercapacitor 324 or battery, a vacuum pump 322, and a computing device 326 (e.g., a CNS 412).

It should further be noted that, for the purposes of this disclosure, the flywheel 304 and MESU assembly 302 are provided only by way of example and that other local energy storage devices are possible and contemplated. In some implementations, the technology may apply to chemical or other energy storage, such as chemical batteries, supercapacitors, flywheels, gravity-based batteries, and/or combinations thereof.

For example, while other implementations are possible and contemplated herein, FIGS. 3A and 3B illustrate example mechanical-energy storage unit (MESU) assemblies 302, that use a flywheel 304 to provide energy storage. As illustrated in the example implementation of FIGS. 3A and 3B, a MESU assembly 302 may include a flywheel housing 306 providing support to a flywheel bearing 308 that provides support to the flywheel 304. The flywheel bearing 308 may suspend and allow a flywheel 304 to rotate within a cavity or space in the flywheel housing 306, for example, about a central axis of rotation. A motor-generator 310 may be coupled or couplable with the flywheel 304 via a flywheel coupler 312 to exert rotational force thereon or receive rotational force therefrom. In some implementations, the MESU assembly 302 may include various other components, such as frames, actuators, electronics, cases, reinforcements, legs 318, etc., which are described elsewhere herein.

It should be noted that, although certain components and configurations are described herein, other implementations are possible and contemplated herein. For example, a MESU assembly 302 may include fewer, additional, or different components. In some implementations, the MESU assembly 302 may have various other configurations, for example, it may be oriented in various directions, such as where a motor 310 is located below the flywheel 304 or at a side of it, or otherwise.

In some implementations, although not illustrated in the examples of FIGS. 3A and 3B, the MESU assembly 302 may include other components, such as inverters, wiring, switches, sensors, transformers, and/or other power converting or transmission equipment that communicates electrical current from and/or to an external power source, such as an electrical service panel, solar panel system, electrical utility grid, etc. The equipment may additionally or alternatively couple the MESU assembly 302 to various loads, such as a power grid, electrical service panel, electric vehicle charger, etc.

In some implementations, the MESU assembly 302 may include and/or be coupled with various control equipment, such as a computing device or other control unit that executes various operations, etc. For example, the MESU assembly 302 may be part of a node 140 and coupled with a flywheel controller 254 and/or node application 240. For example, the MESU assembly 302 control unit may represent an implementation of the flywheel controller or one of its components. The MESU assembly 302 control unit, etc., as described above may perform various operations respective to the MESU assembly 302, such as described in further detail elsewhere herein.

The example MESU assembly 302 may include one or more chemical batteries, supercapacitors, inverters, motors, or other components, which may be monitored by one or more sensors. For instance, the MESU assembly 302 may include temperature, rotation, and acceleration sensors in or adjacent to the bearings or axils of the flywheel. Similarly, temperature sensors may be located adjacent to a chemical battery or other components. An inverter may be coupled with the MESU assembly's 302 controller and may provide various other information, such as current, voltage, etc. Accordingly, as noted in more detail elsewhere herein, status or diagnostic data may be gathered by the controller and used, by the controller (e.g., a flywheel controller 254, node application 240, CNS 412, etc.), to identify faults or other events. The controller may automatically perform operations locally and/or transmit messages to a remote server for further processing.

In some implementations, all or a portion of the MESU assembly 302 may be placed within a case or enclosure to provide protection to the MESU assembly 302, protection from potential flywheel structural failure, and/or a vacuum, which increases flywheel efficiency. For example, a vacuum may be permanent or actively maintained using a vacuum pump 322. An example enclosure is described in further detail below.

For example, as illustrated in FIG. 3B, the enclosure 306 may be fully enclosed to house a flywheel 304 therein. The enclosure 306 may include a vacuum pump 322 coupled with the top of the enclosure 306, which may be powered by the motor/generator 310, supercapacitor 324, a battery (not shown), an external grid, or otherwise. The pump 322 may maintain a given vacuum pressure inside the enclosure 306 in order to reduce resistance on the flywheel 304. In some implementations, the vacuum pump 322 and/or enclosure 306 may include one or more sensors indicating a status and/or pressure of the pump 322 or enclosure 306.

As illustrated in the example of FIG. 3A, the MESU assembly 302 may include a flywheel 304 including one or more plates coupled at a central axis of rotation to a flywheel bearing 308, which allows the flywheel 304 to rotate about the central axis. The flywheel 304 may be housed within and supported (e.g., by the flywheel bearing 308) by the flywheel housing 306. The MESU assembly 302 may include a motor 310 assembly including a motor 310 adapted to convert an input electrical current to rotational momentum by spinning up the flywheel 304 and/or convert the rotational momentum of the flywheel 304 into an output electrical current. The flywheel 304 may be coupled with the motor 310 using a flywheel coupling 312 that imparts rotational force between the motor 310 and the flywheel 304.

In some instances, the flywheel 304 may be allowed to spin or freewheel relative to the flywheel housing 306, for example by allowing a motor 310 to spin freely and/or allow the flywheel coupling 312 to decouple, as described in further detail below. For example, the MESU assembly 302 may include a motor 310 frame 314 that holds the motor 310 and may allow the motor 310 to be moved, depending on the implementation. Additionally, or alternatively, the MESU assembly 302 may include a coupling lifter 316 or other mechanism that electronically couples and/or decouples the flywheel coupling 312 and/or the motor 310 via the motor frame, as described in the examples below.

A flywheel 304 may include a massive wheel that rotates about a central axis. In the example of FIG. 3A, several metal disks may be used and coupled together, for instance using bolts passing through the disks or clamping the disks together. For example, the flywheel 304 may include disks, rings, or a solid structure.

In the example, ten flywheel disks are shown in FIG. 3A; however, other quantities and configurations are possible and contemplated herein. The thicknesses, sizes, shapes, and quantities of the disks or plates may vary. For instance, the number of disks can be varied to adjust the amount of energy storage of a mechanical-energy storage unit where additional disks provide additional storage for a minimum in additional cost and complexity without correspondingly increasing a probability of structural failure. The disks may be solid plates, have various perforations (e.g., for bolts or a hub), be circular or other shapes, or have other configurations. Ideally, the disks are symmetrical or otherwise balanced to reduce vibrations when the flywheel 304 is spinning.

Depending on the implementation, the flywheel 304 may be constructed from aluminum, steel, concrete, composite, another material, or a combination thereof. For example, a set of steel flywheel plates or disks coupled together, each of which may be a quarter inch, half inch, inch, or other dimension thick. Other implementations, such as a combination of aluminum and composite (e.g., carbon fiber, etc.) are described in further detail below. In some implementations, the disks may include or be reinforced using other materials, such as Kevlar®, fiberglass, or carbon fiber, as described elsewhere herein.

The flywheel 304 may have various dimensions that are based on material strengths of the flywheel 304, desired rotational speeds, and/or desired storage capacities. For example, in order to improve manufacturability, decrease danger of material failure, allow the flywheel 304 to be placed at residences or other small-scale applications, the diameter of the flywheel 304 may range between 6 inches to 36 inches, although other sizes are possible. For example, a flywheel 304 may have a diameter of approximately 25 inches and a thickness of 5-12 inches. As noted elsewhere herein, increasing the quantity of disks may increase an energy storage capacity without increasing rotational speeds.

Although many other implementations are possible and contemplated herein, the flywheel 304 may have weights ranging from 100-1500 pounds, spin at 5,000-25,000 RPM, and have storage capacities of 3-15 kWh, depending on their sizes and materials. For example, by increasing the diameter or quantity of plates, the flywheel energy capacity may be increased to 15-500 kWh. These and other examples provided herein are meant as non-limiting examples and various sizes, materials, configurations, and storage capacities are possible and contemplated.

Various radiuses and rotational velocities may be used to address radial and circumferential stresses. For instance, decreasing diameters may decrease radial stresses but also decrease angular momentum. As material strengths increase, rotational speeds may be increased to correspondingly increase energy storage. As noted elsewhere herein, the RPM of the flywheel 304 may be monitored by a control unit (e.g., a flywheel controller 254) based on motor 310 speed or one or more sensors, so that the control unit can determine a current energy storage as well as keep the rotation within a target, efficient, or safe speed.

In some implementations, the flywheel 304 may have an aperture through its center where a hub and/or axil may be placed; although no through-hub is necessary. The hub may include a cylinder coupled to a rod like axil, which, in turn, is coupled with the flywheel coupler 312 or directly coupled with a motor 310, gear, bearing assembly, flywheel bearing 308, or otherwise. The hub may be bolted, glued, welded, or pressure fit to the plates. For instance, during assembly, the hub and plates may be placed together expanded to differing degrees based on temperature or expansion ratios and, when allowed to equalize in temperature, shrink to create tension and gripping force. The disks may be disks or rings around the hub or may be solid at a center and otherwise coupled with the axil.

Returning to FIGS. 3A and 3B, a MESU assembly 302 may include a motor 310 that may be coupled with the flywheel(s) 304, for example, at a central axis, hub, or axil, by a flywheel coupling 312. The motor 310 may be housed in a motor housing, a rotor of the motor 310 may be located at the central axis and coupled with the flywheel coupling 312 to rotate with the flywheel 304, although other implementations, such as where belts, gears, pulleys, or other devices for coupling the motor 310 to the flywheel 304 may be used. The motor 310 may serve as a motor 310 to drive the flywheel 304 and/or a generator to receive energy therefrom.

In some implementations, the mechanical-energy storage unit assembly 302 may include or be coupled with a motor 310, which may be a generator and a motor, and which may spin up the flywheel 304 to add energy and receive energy from the flywheel 304 to send energy to an output. The motor 310 may have various configurations and sizes depending on the quantity or total mass of the flywheels 304, a target rotational velocity of the flywheels 304 or motor 310, a target efficiency, a weight rating, or other implementations. The motor 310 may be coupled with various other electronics, such as an electronic control unit that measures the electrical input or output, rotational velocity of the motor 310, health of the system, position of the flywheel coupling 312, position of the lifter 316, or other statuses. The electronic control unit may cause electrical current from an external source to be input into the flywheel 304 via the motor 310 or output via the motor 310. The motor 310 may also include or be coupled to various other electronics, such as inverters, alternating current converters, transformers, or other electrical devices.

Alternating current motors or direct current motors may be used, for example, the motor 310 may include a permanent magnet motor 310 or, in order to allow the motor 310 to freely spin, the motor 310 may be an induction motor 310 that allows the motor 310 to freely spin when current is not being applied or received, so that the flywheel 304 can freely spin (e.g., where the flywheel coupling 312 is not decouplable). Other types and configurations of motors are possible and contemplated.

As illustrated in the examples of FIGS. 3A and 3B, a motor 310 may be mounted to a flywheel housing 306 using a motor 310 frame 314, which may hold the motor 310 to align the axis of rotation of its rotor with the axil of the flywheel 304. In some implementations, the motor 310 frame 314 may be mounted directly to the flywheel housing 306 (e.g., as shown in FIG. 3B) or it may be mounted via a coupling lifter 316 (e.g., as shown in FIG. 3A) that may move the flywheel coupling 312 (e.g., a motor component) and/or motor 310 to decouple it/them from flywheel 304. For instance, a motor 310 assembly may include a frame 314, motor 310, coupling lifter 316, and/or other components that support the motor 310 and/or flywheel coupling 312.

The flywheel 304 may be housed in a flywheel housing 306, which may be a steel, aluminum, glass, plastic, composite or other housing for providing support to the flywheel(s) 304. For instance, the flywheel housing 306 may include a metal (e.g., aluminum or steel) plate on the top of the flywheel 304, a metal plate on the bottom of the flywheel 304, various reinforcing members, and housing supports for coupling the top and bottom plates. In some implementations, the top metal plate, or other components of the flywheel housing 306, which is near moving magnets (e.g., of the motor 310, flywheel coupling 312, or flywheel bearing 308) may be constructed from plexiglass or another non-conductive material to reduce induced eddy currents and associated inefficiencies.

The MESU assembly 302 may include a flywheel bearing 308 integrated with or coupled with the flywheel housing 306 and providing vertical and/or horizontal support to the flywheel 304. Depending on the implementation, the flywheel bearing 308 may include fluid, magnetic levitation, ball bearings (e.g., ceramic or ceramic hybrid), Teflon®, and/or other bearings. For instance, the flywheel bearing 308 may use a first type of bearing (e.g., ball bearings) horizontally and a second type of bearing (e.g., magnetic levitation) vertically. In other implementations, the flywheel bearing 308 may be completely based on magnetic levitation. The quantity, type, and spacing of magnets in either side of a magnetic levitation bearing may be based on a total mass of the flywheel(s) 304 and/or other spinning structure.

As illustrated in example FIG. 3B, the MESU assembly 302 may support a supercapacitor 324 or a chemical battery that couples with the motor 310 and covers temporary high-current needs in order to start or the motor 310/flywheel 304 moving or stop it. The supercapacitor 324 may include sensors and/or may otherwise communicate with the controller.

As illustrated in the example of FIG. 3B, the MESU may include a computer housing 326, which may support a flywheel controller or CNS (e.g., the CNS 412 described below), an inverter, or various other components. For instance, the CNS may communicate with an inverter, motor 310, sensors, or various other components to detect statuses, events, faults, etc., as described throughout this disclosure.

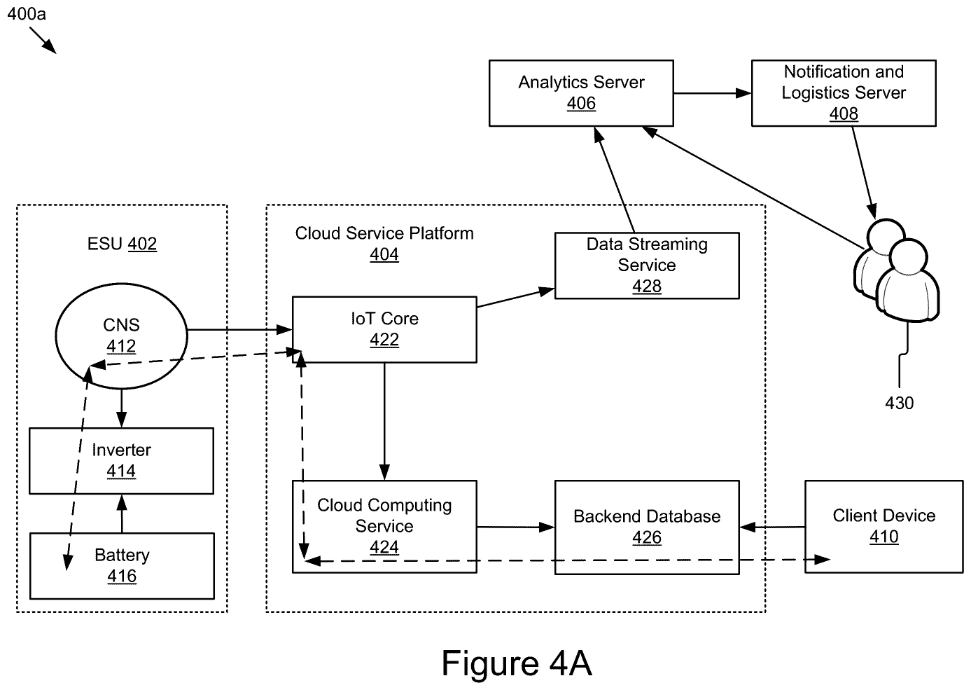

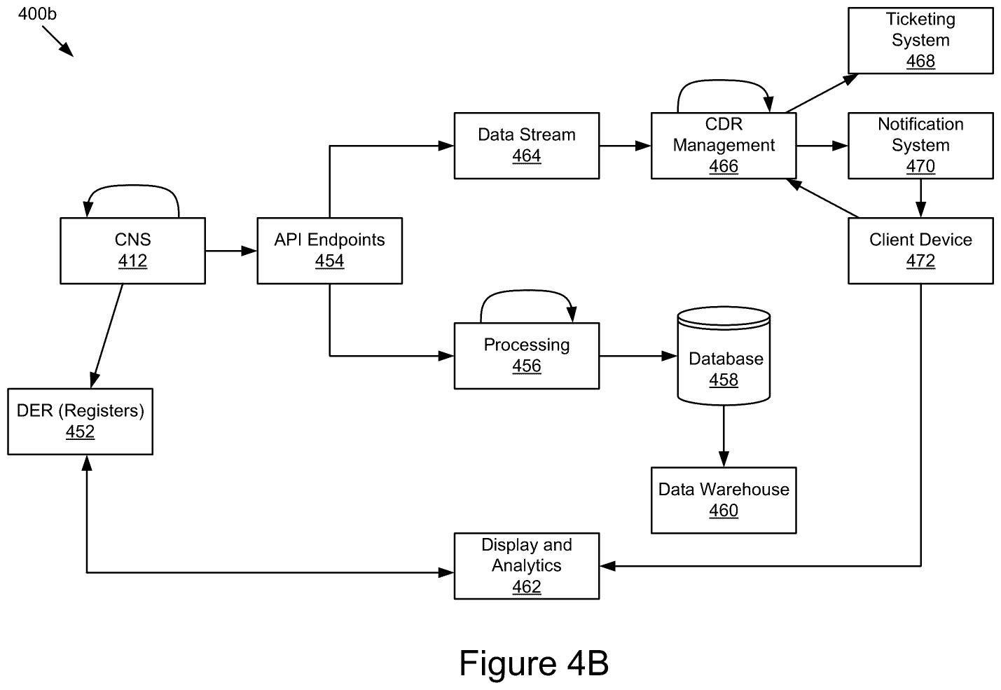

FIG. 4A illustrates an example network configuration 400a of components for monitoring, analyzing, and addressing faults across one or more energy storage devices. In the illustrated example, the example configuration 400a may include a local energy storage unit 402, a cloud service platform 404, and other components, such as a cloud analytics service 406 (e.g., Datadog™), a notification and logistics server 408 (e.g., Opsgenie™), a mobile client device 410, and other devices. Although certain example services are illustrated as using various third-party applications and being executed on separate devices (e.g., a local device 402, a first server(s) 404, a second server(s) 406, etc.), other devices, configurations, and communications are possible and contemplated. As an example, the cloud service platform 404, analytics server 406, and notification and logistics server 408 may represent examples of the CDR server(s) 116.

Depending on the implementation, the CNS 412 or CDR server(s) 116 (e.g., the IoT core 422, cloud computing service 424, analytics server 406, CDR management 466, or other operations, services, or components) may differentiate between normal or non-fault events and those events that include faults. For instance, as described in further detail elsewhere in this application, the CNS 412 or CDR server(s) 116 may compare event data to rules, thresholds, monitors, or other logic to detect anomalies or anomalies events or data that falls outside of defined normal ranges.

Furthermore, as described below and in reference to FIG. 4B, 5, 6, and others herein, rules, thresholds, actions, and other values may be manually or automatically defined in a database against which events or faults may be compared in order to classify or process the associated event data. For example, events may be automatically classified based on defined fields associated with each type of event and/or values thereof to determine whether a fault is associated with a potential automated response or action, with a potential harm, or other details, such as urgency of repairs, specific repair personnel, etc.

As illustrated in the example, the local energy storage unit 402 (also referred to herein as an ESU 402 or energy station) may include a mechanical and/or chemical battery 416 (e.g., a lithium-ion battery, a flywheel, etc.), an inverter 414, and a central nervous system 412 or controller. For example, the ESU 402 may be an example implementation of a MESU 150, node 140, and/or MESU assembly 302 described elsewhere herein. In some implementations, the ESU 402 may include a central nervous system (CNS) 412 communicatively coupled with an inverter 414 and a battery 416 (e.g., via the inverter 414). For instance, the battery 416 may include a chemical battery, mechanical battery (e.g., a flywheel), and/or capacitor.

The ESUs 402 may be divided into groups or clusters based on their geographical area, an electrical grid (e.g., connected to a common sub-station), a neighborhood, or another defined division. The ESUs 402 may be located one at each location or multiple at a single location. The technologies described herein may apply to individual ESUs 402, clusters/groups of ESUs 402, or an entire network. For instance, analytics may be generated for a cluster based on data from a cluster to detect anomalous data of a single ESU 402 versus the other ESUs 402 in a cluster, anomalous data across multiple ESUs 402, etc., as described above. The analysis of what is anomalous may be based on a deviation in the data over a group or over a time period (e.g., 5 minutes, an hour, etc.) or versus defined thresholds.

The battery 416 may send telemetry and other data (e.g., sensor data indicating statuses of the battery 416) and/or current to an inverter 414, which may be communicatively coupled with the CNS 412, which include data processing capabilities, such as the computing device described above. The CNS 412 may read safety registers and receive other data from the inverter 414, control electrical output or input (e.g., to an external load or energy source such as a residence, the electrical grid, etc.) of the battery 416 via the inverter 414, etc. Accordingly, data, such as a battery temperature, may be transmitted from the battery 416 to the inverter 414 and then to the CNS 412 where it is processed, as described in further detail below. For instance, the CNS 412 may determine an excessive heat fault in the battery 416 and immediately instruct the battery 416 to shut down, vent, or otherwise take remedial action. The CNS 412 may, additionally or alternatively, generate and transmit data to the cloud service 404, which may include telemetry, faults, and other identifying or status information via MQTT (Message Queuing Telemetry Transport).

The cloud service platform 404 may include various software services executed on one or more servers, which may be located remotely from the ESU 402. For instance, an Internet-of-Things core 422 executed on AWS (Amazon Web Services™), Microsoft Assure™, IMB Cloud™, or another web services platform, may receive the telemetry and fault data/message from the ESU 402, and it may apply message routing rules to send a message, based on the data, to a cloud computing service 424 (e.g., AWS Lambda™), which may include a compute cloud service provided by a third-party that may process the message, store the data/message, and store it in a backend database 426. For instance, the IoT core 422 may determine a topic based on the type of event, such as whether it relates to temperature, flywheel speed, charge state, network connection status, or other event types and use those event types or topics to route data to a backend database 426, data streaming service 428, analytics server 406, and/or locations on these components.

The database 426 and/or messages may be accessed by a client computing device 410, such as a smartphone application (e.g., on the client device 410) to provide real-time notifications and data indicating the health or status of the local ESU 402. For example, the CNS 412 may send a message to the cloud service platform 404 including data identifying and describing the battery 416, inverter 414, sensors, and/or other devices, including events or faults; the cloud service platform 404 may process the data (e.g., to add flags or formatting for storage and use by another device) received from the CNS 412 according to a defined set of data-processing rules; and a mobile application may access the data and display it in a graphical user interface including, for example, an indication of events, faults, or alerts to the user. In some implementations, the mobile application may additionally or alternatively indicate alert severity levels, remedial actions, repair status, or other data, as described in further detail below.

In some implementations, the cloud service platform 404 may apply message routing rules (e.g., based on a topic, event type, ESU 402 location, or other context data) to the data to route the data through a data streaming service 428 (e.g., AWS Kinesis™) to a cloud analytics service/server 406 (e.g., Datadog™), which may execute defined rules and routines for analyzing, routing, aggregating, and displaying data. For instance, the cloud service platform 404 may determine that the data includes telemetry and/or fault data and may, accordingly, push it (e.g., via AWS Kinesis™) to the analytics server 406. It should be further noted that the divisions and distributions of operations may be on different devices, the same devices, as illustrated, or different from that illustrated. As described in further detail elsewhere herein, routing, processing, storage, and/or analysis of data may be performed based on a set of logical rules executed on one or multiple devices.

In some implementations, the analytics server 406 may process the data, potentially in conjunction with other data or faults for the same or additional ESUs 402, to determine severity level, remediation actions, etc., and may provide analytics to administrators via a web interface (e.g., as described below) and/or to customers on their mobile applications (e.g., by sending the data to the database at 404 or allowing access via the analytics server 406). The processing of the data to determine fault levels and other analysis and operations are described in further detail throughout this application.

In some implementations, as described in further detail below, the analytics server 406 may execute code, routines, or rules that analyze the data from the ESU(s) 402 and automatically perform actions. For instance, as described below, the analytics server 406 may triage the faults to determine a severity level and, based on the fault, severity level, and/or other information, transmit a message to a notification and logistics server 408. The notification server 408 may determine a party to contact based on the message and may then send a message (e.g., SMS message, email, etc.) to a client computing device 430 of a defined party, such as a repair person or engineer. For instance, if a certain type of repair in a certain geographic region (with a certain priority level, etc.) is identified, the notification server 408 may automatically dispatch a corresponding repair truck. In another implementation, if an emergency event is identified in the message (e.g., a battery fire), the notification server 408 may automatically request that emergency fire and/or medical services be sent to the location of the ESU 402, which may be identified in the message). For example, the notification service 408 may send SMS, MMS, or other text messages, phone calls, push messages, or other types of communications to client devices 410 associated with repair personal, local emergency services, or other administrators (e.g., a customer, a customer-service team, a subdivision manager, etc., as identified in notification rules on the notification server 408).

In some implementations, the analytics server 406 may compare data received from a first ESU 402 with data received from one or more additional ESUs 402 in a group, cluster, or region to identify problems over a larger network, issue remedies that maintain stability across the group of ESU 402 or grid, and/or identify outliers. Accordingly, larger-scale faults can be detected, anomalous or mis-performing devices can be identified, and remedies can be proactively dispatched.

In some implementations, the notified stakeholders (e.g., repair teams, administrators, etc.) may access the analytics server 406 to view the telemetry or fault data to further assess its severity, for example, the analytics server 406 and notification server 408 may include a link in the notification to the corresponding data to allow rapid access by the stakeholder(s).

In some implementations, the analytics server 406 may receive (e.g., from the stakeholder) a user input correcting or modifying the severity level, fault, or remedy generated by the logic executed on the analytics server 406. In some implementations, the analytics server 406 may use the feedback to train machine-learning models (e.g., various supervised or un-supervised learning models) or weights for determining future triage, severity, fault, or alert thresholds, which may improve false positive or false negative rates.

It should be noted that other architectures and features are possible and contemplated. For instance, the data may be processed on one or more different first- or third-party servers, on a CNS 412, etc.

As illustrated in FIG. 4A, a dashed line illustrates an example data path illustrating an analysis process for data generated by an event. It should be noted that the data, processing, and corresponding devices are provided by way of example and that others are possible and contemplated herein. For instance, a sensor coupled with the battery 416 may include an accelerometer that senses vibrations from a flywheel in the ESU 402. The accelerometer may be communicatively coupled with the CNS 412 (directly or via the inverter 414), for example, to store or send data thereto. For example, the accelerometer data may be stored on a data storage device of the CNS 412 and/or the CNS 412 may stream and/or process the data.

In some implementations, the CNS 412 may use IoT standards, such as MQTT encrypted using TLS (transport layer security) to stream telemetry, etc., data, such as including data from the accelerometer or a derivative thereof, to an external server or computing devices, such as the cloud service platform 404. An IoT core 422 may, for example, route the accelerometer data based on its context to an analysis server, such as the cloud computing service 424. For example, the IoT core 422 may route the data to a process in the cloud computing service 424, which may process the data to store it on a backend database 426.

In some instances, where the accelerometer data includes an event, for example, exceeding a defined threshold. It may be classified or tagged as a fault by the CNS 412, IoT core 422, or another component. In such instances, it may be routed or streamed to an analytics service or server 406 for further processing, as described in further detail below.

Accordingly, the accelerometer data may be processed locally on the ESU 402, stored on a remote server, and/or routed directly to an analytics service or server 406 to detect faults, classify alerts, and issue corresponding responses. Thus, in some implementations, the data may be efficiently monitored, and events may be detected in a way that combines local capabilities and remote resources to allow continuous event detection and response.

FIG. 4B illustrates another example network configuration 400b of components for monitoring, analyzing, and addressing faults across one or more energy storage devices. Depending on the implementation, the example configuration 400b may be used in addition to or in the alternative to the configuration 400a. In some implementations, one or more devices, messages, or operations may be exchanged between the configurations 400a and 400b. For instance, aspects of the example configuration 400b may be used with aspects of the configuration 400b and vice versa. Accordingly, the example configuration 400b provides additional or alternative details to the configuration 400a described in reference to 400a. As an example, the API endpoints 454, CDR management service 466, ticketing system 468, notification system 470, etc., may represent examples of the CDR server(s) 116.

In some implementations, the CNS 412 may access device registers 452, such as DER (distributed energy resource) device registers, that receive data from various sources on one or more ESUs 402, such as physical or digital sensors of a battery 416 or inverter 414 (not shown in FIG. 4B). A DER device may additionally or alternatively include any device that uses, produces, or stores energy or devices that senses associated parameters, such as a thermometer or thermostat, battery controller, flywheel controller, accelerometer, HVAC device, or many other devices. For example, the CNS 412 may read or write to registers via a controller area network (e.g., RS485) to communicate with devices and sensors, process and compare data locally, etc. The CNS 412 may perform continuous local processing of the DER telemetry and may, using the telemetry data, classify events into faults and report the faults, for example, to an external CDR server(s) 116 for further storage, analysis, processing, reporting, or other actions.

In some implementations, where the CNS 412 detects a fault and determines that the fault includes a defined local response, it may perform one or more automated local actions to attempt to locally resolve the fault. Depending on the fault, automated response, and effect thereof, the fault data may also be routed through to an analysis server or CDR management device 466, as described elsewhere herein.

As discussed above, the CNS 412 may transmit telemetry or fault data (e.g., using TLS-encrypted MQTT protocol), for example, which may be routed through application programming interface (API) endpoints to one or more other services, for example, based on the types of faults/events/telemetry data. The API endpoints 454 may also route or transmit encrypted (e.g., using TLS) data to various other services and/or devices. For example, the API endpoints 454 may send a data stream 464 to a CDR management service 466 (e.g., executed on a CDR server(s) 116 or analysis server).

The CDR management server 466 may decrypt the data and perform continuous telemetry and fault processing to identify anomalous activity and alerts. Depending on the identified alerts, etc., the CDR management service may send data to a ticketing system 468, which performs ticketing automation. For instance, it may process an alert and/or other event data (e.g., location, type, etc.) through a decision tree or other logic to automatically create one or more service or response tickets that may be monitored by stakeholders, sent via a notification system 470, or otherwise processed, as described elsewhere herein.

The CDR management service 466 may send alerts and/or ticket information to the notification system 470, which identifies stakeholders, based on the tickets, alerts, or associated data. For instance, if an alert indicates a low severity vibration from a flywheel in a define geographical region, the CDR management service 466 may automatically generate a ticket, assign a flywheel technician, and send a notification to the technician indicating location, severity, alert type, etc., data associated with the alert. For instance, the notification system 470 may automatically determine notification preferences (e.g., e-mail, SMS or MMS message, push notification, etc.) and a client device 472 (e.g., a personal computer, smartphone, wearable, etc., associated with the technician or where a user application 172 is executed) for the notification. In some implementations, alerts, notifications, or associated data may additionally or alternatively be sent to engineers, product designers, administrators, emergency responders, residents, and/or other users/stakeholders.

In some implementations, the stakeholders, such as support engineers, may review the alert and provide user input (e.g., via the user application 172) regarding the alerts. For instance, they may indicate the status of a response, or they may modify the response. In some implementations, the support engineer(s) may modify a severity level, manually triage alerts, or provide other inputs.

In some implementations, the engineer responses may provide a training dataset that may be used to train and/or test a supervised-learning machine learning model or other weights or thresholds. For example, as feedback is fed into the training algorithms used by the CDR management service 466 to adjust the weights or thresholds used to generate alerts from faults or events, as described in further detail elsewhere herein.

In some implementations, the API endpoints 454 may send the telemetry, fault, event, or other encrypted or non-encrypted data for processing. For example, one or more processors 456 may continuously process telemetry and fault data for access, analysis, display, storage, etc., of the data via web or mobile-application user interfaces. For instance, the processing 456 may be of various MQTT message types, such as telemetry, debug, or fault data, although other types are possible and contemplated herein.

In some implementations, after processing 456, various types of data may be stored in a database 458 and/or in a data warehouse 460 (e.g., for longer term storage), which allows the data to be analyzed, viewed, or otherwise retrieved.

The feedback from a client device at 472 may be stored or displayed, at 462, in a display and analytics service, for example, along with data from the DER registers and other event or other data from an ESU 402 or node 140 (e.g., as reported to the databases 458 or 460 by the CNS 412).

Accordingly, the example continuous detection and response architectures 400a and 400b illustrated and described in reference to FIGS. 4A and 4B may provide an efficient way to detect, route, process, and respond to various events. For example, the example architectures 400a and 400b allow a multi-stage categorization or triage of events, which may result in a local response and/or elevation to further routing, categorization, and response.

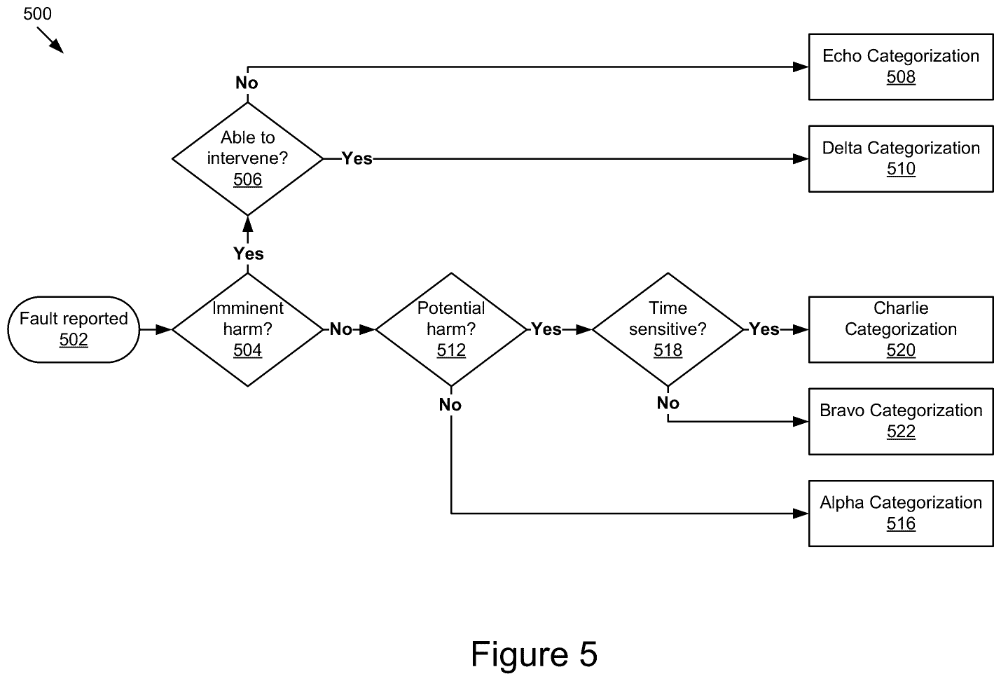

FIG. 5 is an example flowchart depicting a fault categorization decision tree 500 for classifying faults. The decision tree 500 could be executed on a CNS 412, cloud server, analytics server 406, and/or another device, depending on the implementation. The decision tree 500 may be used to classify faults, for example, into alerts with defined severity levels or classifications. It should be noted that, although it is described in reference to alert severity levels, it may be used with other classifications, such as types of faults, types of responses, etc.

For example, for the purposes of the description of FIG. 5 and other figures herein, a fault may include a pre-defined definition of an abnormality relating to the ESU 402, a cluster of ESUs 402, or another system, an active fault may be an actively detected abnormality relating to the ESU 402 or another system, an alert may be an escalated abnormal event that may use automated local response or that may require external intervention based on the risk to the ESU 402 or another system's safety, and an action maybe a series of steps to escalate, deescalate, and troubleshoot alerts, which may also account for impact to the customer or others' experience.

For example, the system (e.g., an analytics server 406, CNS 412, and/or another device) may receive a notification of a fault (e.g., from a CNS 412 of an ESU 402) at 502. At 504, the system may determine if an event may result in immediate harm, for example, to the ESU 402, for example, based on details of the event/fault (e.g., sensor data, type of sensor, type of event, etc.), values associated with the event (e.g., acceleration values, voltages, temperatures, etc.), and associated parameters. For instance, the system may determine that an event (e.g., a temperature) exceeds a threshold programmed into the system for that type of event (e.g., exceeding 100 degrees), the system may determine that immediate harm is possible and immediately move to the next step.

At 506, if, based on the fault and its parameters, the system determines that imminent harm is possible (e.g., based on a defined fault or threshold levels thereof), the system may determine whether it is able to intervene. For instance, the system may determine whether there are immediate responses defined for the event and/or its values, such as that it could shut down a battery 416, flywheel, or other component to mitigate damage. If the system determines that it is unable to intervene (e.g., based on a type of fault or its level), the fault may be categorized at a highest or “echo” level at 508. Echo may indicate damage control or clean up rather than mitigation. If the system determines that it is able to intervene, it may do so (e.g., by sending a message to the CNS 412 to restart, shut down, spin down, vent, etc.), and may categorize the fault as “delta” level at 510. For example, the delta level may cause a closest repair resource to deescalate the situation. For example, as described above, a ticket may be automatically generated and an associated notification may be sent to a stakeholder's client device indicating the alert, severity level, associated details, and/or recommended responses/remediations.

In some instances, where the system determines that there is no imminent (e.g., withing a defined time period) harm to the system at 504, it may determine whether the fault is classified (e.g., in a data table of fault definitions) as potentially resulting in harm at 512. If there is no potential harm (for example, a temporary failure to communicate), it may be classified as a lowest or “alpha” level at 516.

If the system determines that the fault may cause potential harm at 512, it may then determine whether the fault is time sensitive at 518. If a definition or attribute of the fault type indicates that it is time sensitive, the system may classify it under “Charlie” level at 520. For instance, a bad bearing could deteriorate, so the system may determine that elevated bearing/axil temperatures at a certain speed are time sensitive and has potential harm, so it may classify the fault as “charlie” level. If the fault is not time sensitive (e.g., a bad bearing slightly reduces performance), it may be classified as “bravo” level at 522.

Various severity or risk levels to which a fault may be classified may be used and associated with thresholds, weights, values, colors, or alphabetical codes. Various actions, stakeholders, data routing instructions, etc., may be triggered responsive to a fault being classified into a certain category. For instance, the actions may range from monitoring the fault, dispatching repair resources, to notifying emergency services. Accordingly, faults can be quickly and automatically classified, which leads to increased safety that is proactive instead of merely responsive. Similarly, maintenance and repairs can be performed proactively using data from local devices that was not previously available.

Each of the categories may also include sub-categories for types of alerts, such as those relating to software, hardware, chemical batteries, flywheel batteries, etc. Accordingly, using the alert type, severity level, sub categorizations, flags, or other details, the alerts can be routed, responses may be issued, and notifications sent, as described in further detail above.

As an example of an alpha-level alert, the risk may be low, time may not affect the outcome, and there is no direct threat to safety. An example associated action (e.g., used as a response or automatically processed by the system) may include monitoring the alert (e.g., and/or the associated conditions from the ESU 402) and scheduling remediation accordingly.

As an example of a bravo-level alert, the risk may be moderate, the response time may affect the outcome, and there is no direct threat to safety. An example associated action may include priority scheduling of a skill set (e.g., a repair technician having a skill set associated with the alert) to resolve the alert.

As an example of a charlie-level alert, the risk may be high, the response time may affect the outcome, and there is a potential threat to safety. An example associated action may include immediately dispatching medium-level (e.g., tier 3, medium level response/repair personnel) resources with high-level (e.g., tier 4) resources on standby to monitor the situation while the medium-level resources are in route to perform critical de-escalation. For instance, notifications may be sent to each of these parties based on their defined roles.

As an example of a delta-level alert, the risk may be imminent, the response time will affect the outcome, and there is an imminent threat to safety. An example associated action may include immediately dispatching a geographically closest stakeholder and high-level resources; and potentially alerting emergency services, as needed.

As an example of an echo-level alert, the risk may be a potential total loss and property and asset(s) may no longer be recoverable. An example associated action may include notifying emergency services, if they have not already been notified, and notifying one or more executive team member to address the alert and associated incidents.

It should be noted that although certain alerts, alert parameters, and actions are described, others are possible and contemplated herein.

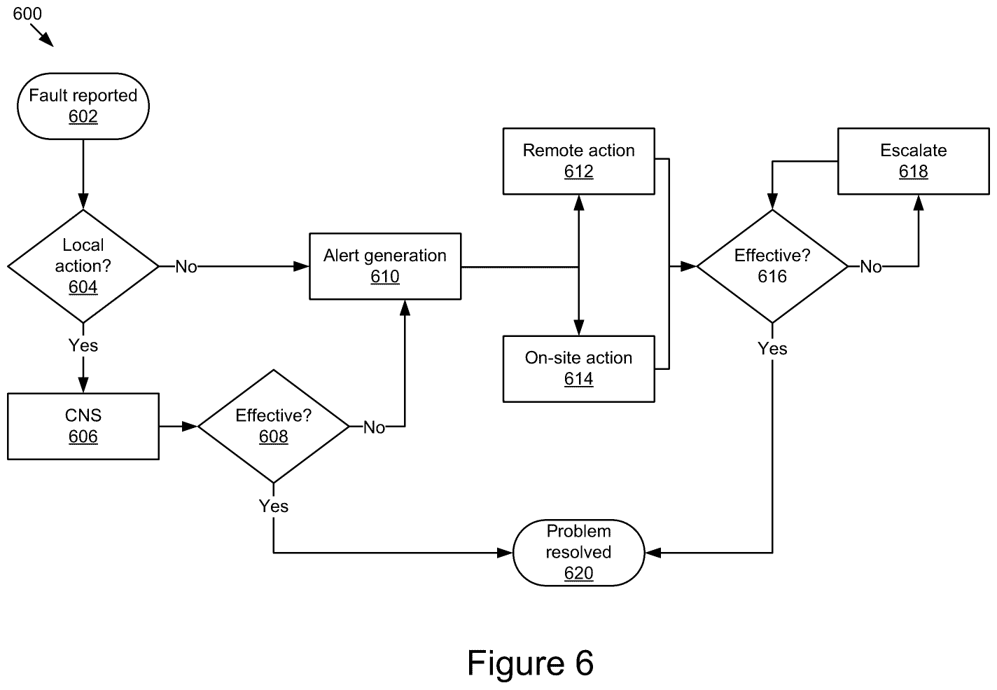

FIG. 6 illustrates a flowchart depicting an example alert and action processing flow 600, which may indicate, for instance, associated services and devices with actions or other operations.

In some implementations, the method of FIG. 6 may start at 602 where the fault is reported. For instance, local hardware (e.g., the CNS 412 of an ESU 402 at a customer's residence) may generate a fault based on a local event and send it to an analytics system (e.g., the analytics server 406), which may alert or log that fault, as noted above.

At 604, the system may determine whether local action is possible or defined in association with the fault. In some implementations, if local action is possible, at 606, the local hardware may additionally or alternatively take local action, such as spinning down a flywheel, discharging a battery 416, shutting off a current, etc. An example of a fault may include that the battery 416 has a high voltage beyond a defined threshold, or the battery 416 temperature is too high. A fault may be based on multiple criteria (e.g., both voltage and temperature). In some instances, if multiple faults are generated or received at the same time, the system may change the classification of an alert, for example, to indicate a higher severity or priority level.

For example, as noted above, the CNS 412 may receive and/or transmit data describing a status or health of the ESUs 402 periodically, such as every 50 milliseconds (although other rates are possible and contemplated herein), so that the CNS 412, analytics server 406, and/or other systems know, in nearly real time, what is happening at individual ESUs 402. Accordingly, the system may have nearly instantaneous and continuous data for each node, which may be used to quickly determine and address faults. Furthermore, as this data may be timestamped and associated with determined events, machine learning models may be trained to develop predictive models to identify faults before damage is caused or further improve processing accuracy. For instance, while previous methods may have reacted to problems, the data-availability and predictive models may detect and address faults before they develop into more serious problems that could affect the functioning or safety of the system, or impact customer experience.

At 606, the CNS 412 may address the issue within the system in a closed loop, for example, instead of (or prior to) a human repair person performing a manual intervention. For instance, once the CNS 412 generates a fault, it may determine whether local action is possible (e.g., based on a file indicating defined set of actions respective to each fault or fault combination). For instance, the CNS 412 or analytics server 406 may determine that local action is possible and instruct a local action (e.g., by the CNS 412), such as restarting a device, modifying a state of charge, freewheeling a flywheel, etc.

As an example, if the CNS 412 or CDR server(s) 116 determines that a local action is possible based on received data (e.g., based on a thermometer data or communications from a battery, that a temperature of the battery is too high), the CNS 412 may shut down the battery or perform further diagnostics, power cycle the battery 416, power cycle the inverter 414, push software/firmware updates to various devices, turn battery warmers on or off, or perform other operations that are defined in a fault definition database. As another example, based on data gathered for an event, the system may determine that the event is a fault (e.g., based on a definition in a database), for instance, where voltage drops beyond a defined threshold or is a threshold miss-match of voltage or phase (e.g., where an inverter is matching alternating current frequency of an external power grid), the system may instruct the inverter 416 to dissipate energy, drop/raise voltage, adjust frequency, or perform other defined, automated operations to stabilize the node 140 relative to the grid.

At 608, the system (e.g., CNS 412 or CDR server(s) 116) may determine whether the solution was effective, for example, by pinging the local hardware or waiting for another fault code or other status data.

At 610, if the local action is not available or if it was not effective, then the system (CNS 412 or CDR server(s) 116, as noted above) may determine an alert to indicate whether or not a repair should be performed. In some instances, based on the alert, it may transmit a message to a notification server to dispatch a repair vehicle or have another system or administrator perform an action to deescalate the alert.

For example, if the notification requests that a stakeholder or system perform an action, they may perform a remote action at 612 or an on-site action at 614 (e.g., determined and routed as noted above). For instance, if a response or action is defined as being a remote action, such as adjusting spin rate, restarting a system, monitoring an event, etc., a remote service or technician may perform the remote action. Additionally, or alternatively, a technician may be dispatched to take on-site action, as discussed above.

Based on a fault message, continued monitoring, or administrator/human input, the system may determine whether the remedy was effective at 616. If the remedy was not effective, the system may reclassify the fault/alert to a higher level of severity and perform corresponding actions at 618. Accordingly, the fault may be elevated until it is resolved. On the other hand, if the system determines that the action was effective in remedying the fault, it may update a corresponding ticket to be resolved, temporarily monitored, or otherwise at 620.

Accordingly, in combination with the local data and triaging, the system may self-heal and/or self-diagnose. In some instances, these self-healing actions may include checking for false positives or other error correction, as noted elsewhere herein. For example, the system may detect a voltage spike that exceeds thresholds and classify it as a fault. Based on the voltage spike's parameters (e.g., voltage, value respective to thresholds, duration, etc.), the system may determine to wait to see if additional spikes are detected within a defined time period. If spikes or other faults are detected within the time period, then they may be escalated, but if no additional faults are detected, the system may mark the fault as resolved.

Accordingly, the system may proactively and accurately detect faults that could be dangerous or require immediate action, such as a thermal runaway event, which allows the system to dispatch repair and/or emergency personnel. While previous systems did not have accurate or up-to-date data about a local system, such as a battery 416 or flywheel at a residence, the present technology allows dispatched repair and/or emergency personnel to be prepared for specific circumstances of a fault as well as answer it more quickly. Because the system rapidly self-diagnoses, self-heals (or performs mitigation measures), resources are more efficiently used, alerts are responded to more quickly, and safety is increased. Thus, the present technology is more proactive, faster, and sensitive than previous systems.

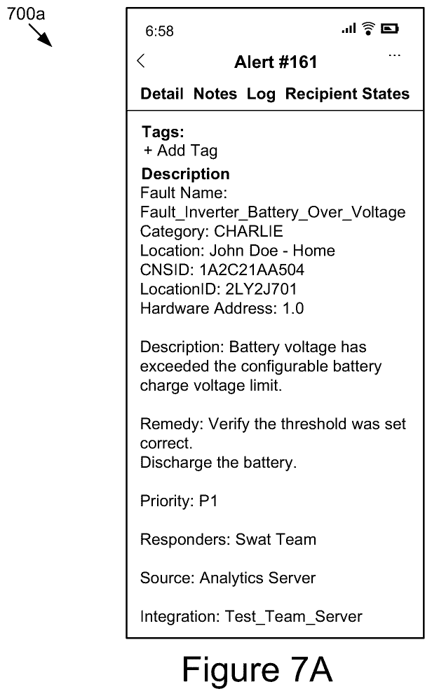

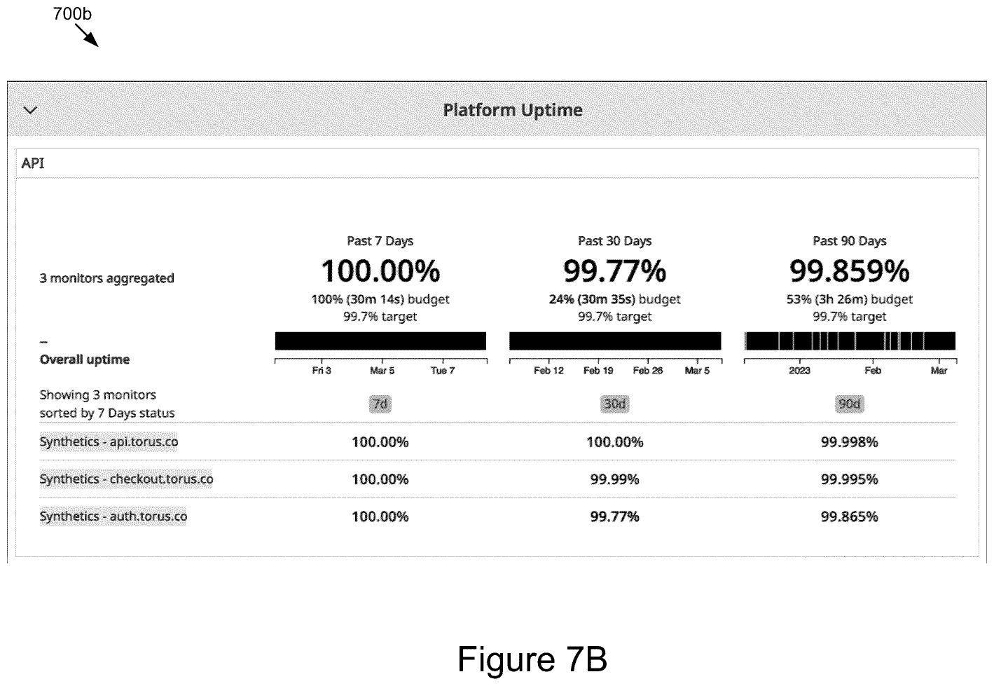

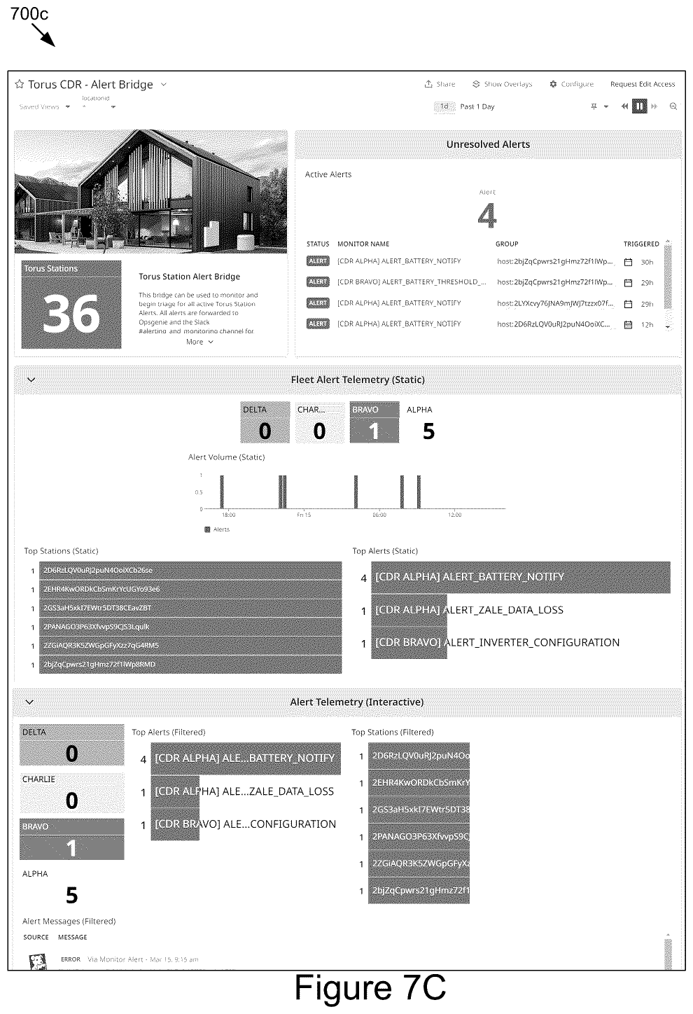

FIG. 7A illustrates an example graphical user interface 700a that may be displayed by a mobile application showing an example alert. For example, the interface of FIG. 7A may be displayed on a repair technician's mobile phone, although other implementations are possible. As illustrated, a fault may include a battery 416 high voltage event where a battery 416 has exceeded a configurable voltage limit, for example, as reported by an inverter 414 coupled with the battery 416. The notification of the alert may also show the fault name, category/severity, location name, location ID, proposed automatic and/or manual remedies, priority level, timestamp, assigned responders, source, and other data.

FIG. 7B illustrates an example graphical user interface 700b showing statistics for one or more ESUs 402 over various time periods. For instance, the system may use the detected faults to automatically generate analytics for various statuses or faults, etc. For instance, the interface 700a illustrated in FIG. 7B includes graphical elements (text, graphs, or other graphics) indicating downtime/uptime, percentages, and other details over various time periods. In the illustrated example, the data is shown aggregated from multiple ESUs 402 and may be totaled or averaged across the group.

FIG. 7C illustrates an example graphical user interface 700c, which shows an alert bridge in which various alert data may be displayed to a stakeholder. For instance, the interface shows the number of nodes being monitored (e.g., in a defined cluster), a quantity and timing of resolved and unresolved alerts, alert telemetry data, and other data. For instance, graphs may be shown illustrating total alerts and their types and timing, and other data over a defined time period or group of nodes/ESUs 402.

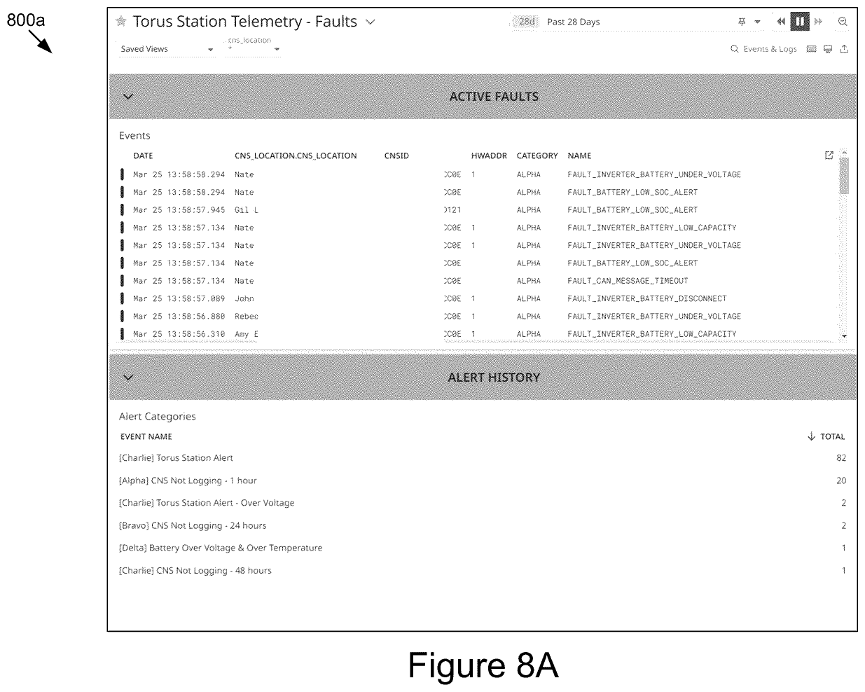

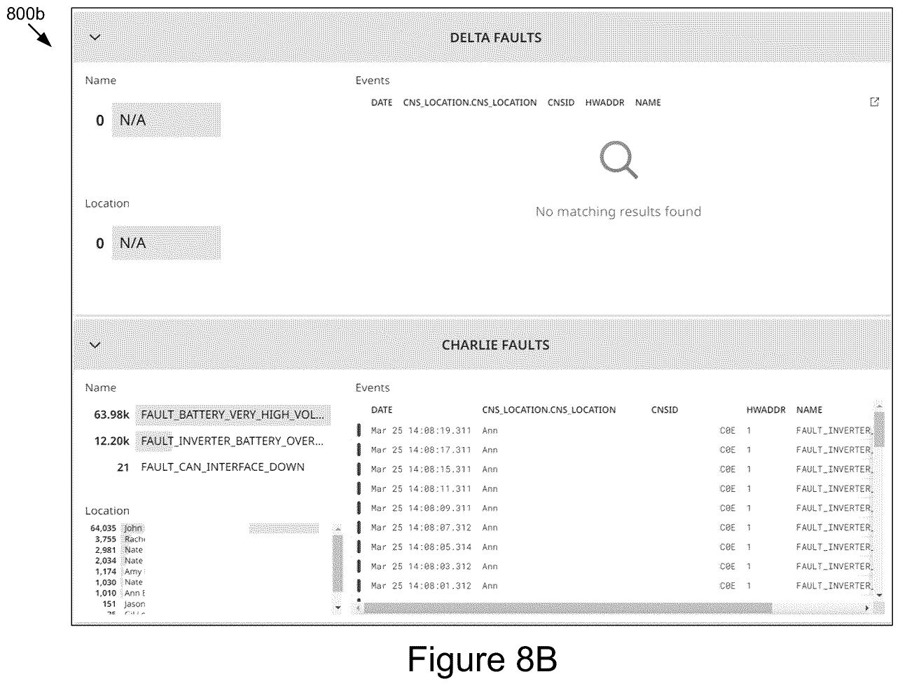

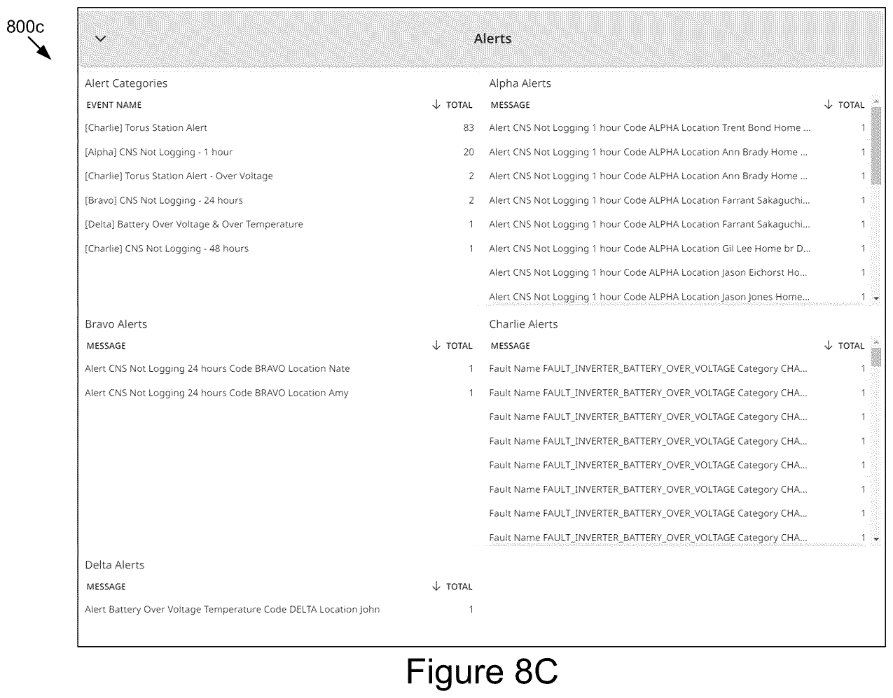

FIGS. 8A-8C illustrate example interfaces 800a, 800b, and 800c in which faults are identified for one or more ESUs 402. For instance, scrolling down on the interface 800a may show interface 800b and, in turn, scrolling down on interface 800b may show interface 800c. As illustrated, data may be analyzed (e.g., by an analysis server, CDR server(s) 116, etc., as described above) and aggregated over a plurality of ESUs 402 to provide visibility for safety, maintenance, repairs, etc. For instance, the interface(s) 800a-800c in FIGS. 8A-8C may be displayed to an administrative user overseeing a group of ESUs 402, for example, in a state, city, energy utility area, subdivision, etc.

FIG. 8A shows a list of events, which may represent faults, which include time stamps, locations, device IDs, fault category/severity, fault name, and other details. The interface 800a may also show bucketized lists of faults based on category/severity level, so that a user can easily ascertain which faults have the highest priority. Furthermore, the interface 800a may show a history of alerts to indicate an aging of each type of alert and therefore an overall health and maintenance level of a cluster of nodes, ESUs 402, or other devices.

As shown in the example interface 800b of FIG. 8B and 800c of FIG. 8C, graphical boxes may also be shown displaying lists of details for each category of fault. For instance, graphical subdivisions of the interfaces 800b and 800c list details for various alerts/alert levels, such as their quantity, priority, location, name, severity, aging (e.g., how long since the event occurred or started occurring), messages, assigned response personnel, category, tag, or other data.

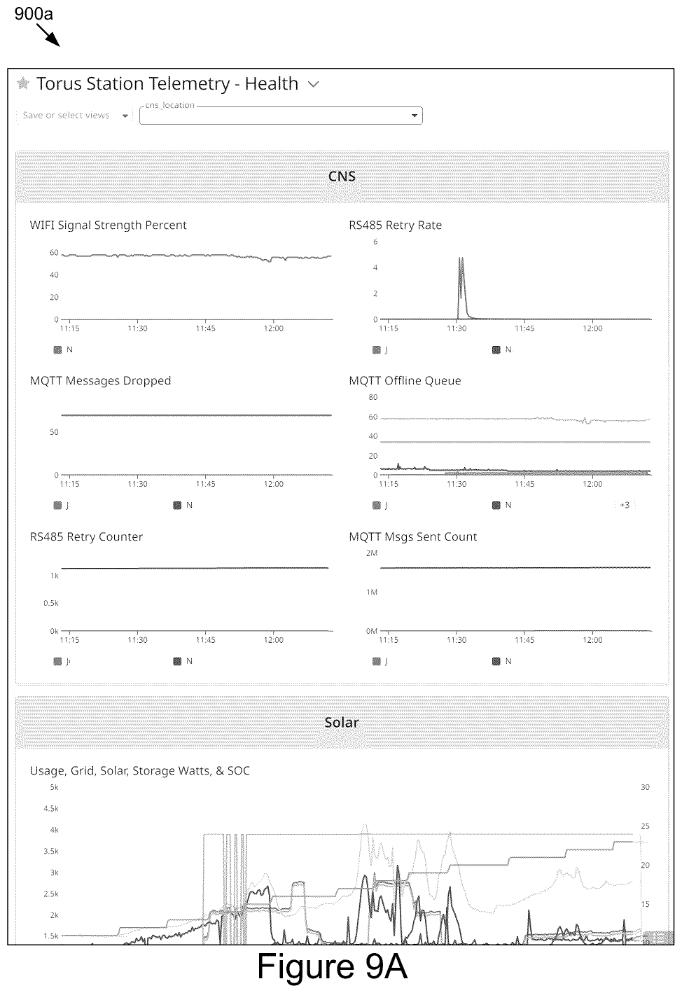

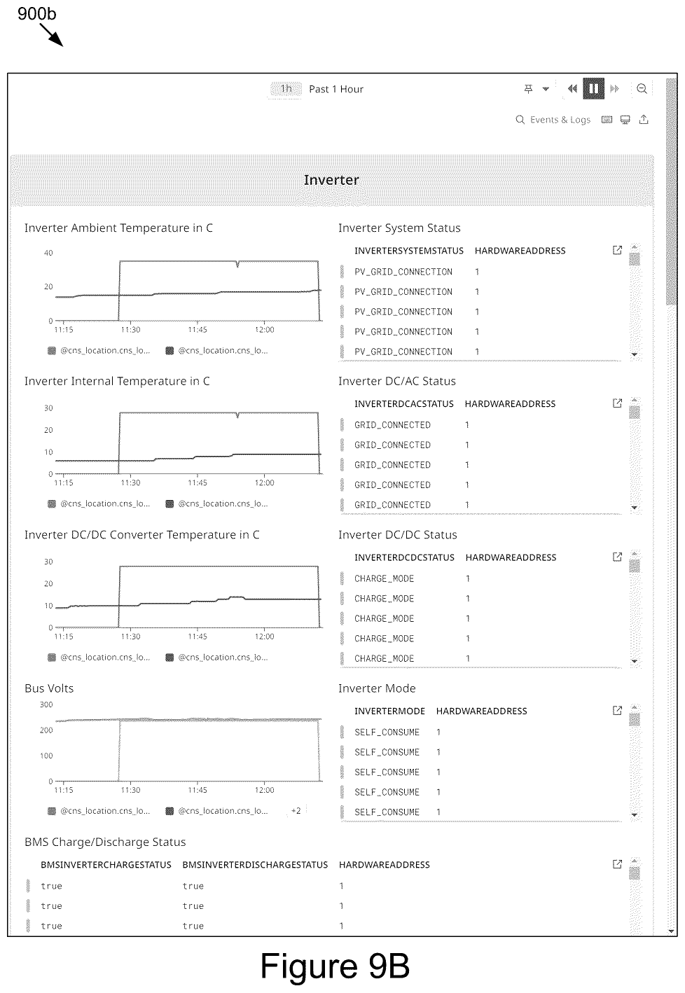

FIGS. 9A and 9B illustrate graphical interfaces 900a and 900b showing health telemetry data across one or more ESUs 402 generated, for example, by the CDR server(s) 116 (e.g., the analytics server 406). The interfaces 900a and 900b may be displayed together on a single computer display, for example, side by side, vertically (e.g., when scrolling), or may otherwise be dynamically arranged based on display or window size and resolution.

The interfaces 900a and 900b may display real-time or near real-time, updated graphs and lists for each of the types of data or sensors monitored for selected ESU(s) 402 or node(s). Depending on the implementation, additional or fewer graphs for one or more locations or ESUs 402 may be shown. The graphs, lists, and other graphical elements may be automatically updated as data is received from the ESU(s) 402.

In some implementations, the graphical user interfaces 900a and 900b may additionally or alternatively display information specifically for one or more components of an ESU 402, node, or network thereof. For instance, the interfaces 900a and 900b may include graphical divisions, frames, or widgets that display information for an inverter 414, chemical battery, or flywheel energy storage system (FESS). It should be noted that additional or fewer widgets may be added depending on configuration of an ESU 402/node or based on user preferences. For example, the interfaces 900a and 900b may display data and analytics specifically for a FESS, such as flywheel RPMs, battery volts, battery amps, battery watts, FESS capacity percent, leak rate (e.g., due to friction), vacuum pressure, FESS energy in watt hours, battery watts, solar watts, usage watts, grid watts, upper and lower bearing temperatures, motor temperature, or other data.

For instance, the analytics server 406 or another component (e.g., as described above) of the system may collect, aggregate, analyze, and display Wi-Fi signal strength, MQTT messages dropped, RS485 retry counter and date, MQTT offline que, MQTT messages sent count, inverter ambient temperature, inverter internal temperature, inverter DC/DC converter temperature, bus volts, inverter system status, inverter DC/AC status, inverter DC/DC status, inverter mode, usage by various devices (from the grid, solar, storage watts, etc.), state of charge, BMS charge/discharge status, solar volts and watts, solar amps, grid, inverter, electricity sensor data, usage watts, storage watts, solar watts, electricity meter phase A/B, grid watts, flywheel rpms, upper bearings temperature, lower bearings temperature, vacuum pressure, battery amps, battery charge volts, battery volts, battery storage capacity percent, battery discharge amps, battery temperature, battery charge amps, battery watts, zero current calibration factor, storage (watts), battery (amps), battery (volts), and storage capacity, storage (capacity percent), impedance, battery (charge amps), battery (discharge amps, temperature, whether the inverter is in grid-powered bypass mode, and other data, although other data is possible and contemplated.

Accordingly, the CDR server(s) 116 may have access to various data that is received from sensors or other data sources or derived therefrom, which it may use in the operations described above. The analytics may be displayed in a graphical user interface (e.g., 900a or 900b) and/or used to detect faults, alerts, severity levels, etc., as described above. Furthermore, where a human is viewing the interfaces, the analysis server may overlay data for multiple devices so that differences (e.g., anomalous events) may be more easily discerned.

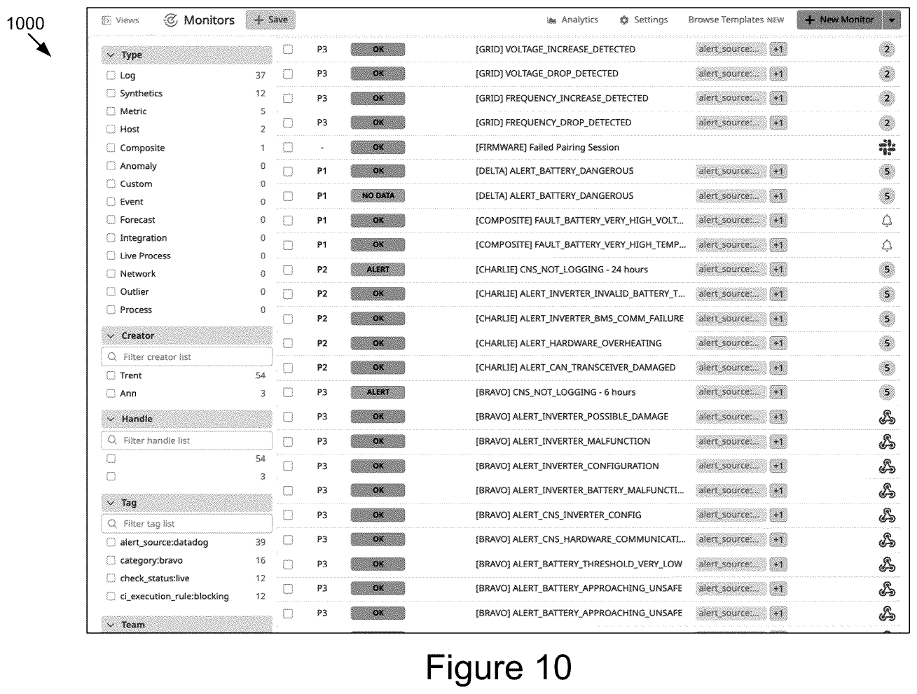

FIG. 10 illustrates an example graphical user interface 1000 in which various monitors are listed, along with alert status and filtering data (e.g., priority, type, muted, etc.). Monitors may include rules or logic that monitor event data from ESUs 402. For instance, a monitor may determine and/or classify types of events, compare event data against thresholds, quantities, qualities, etc., to determine whether the event includes a fault. Other example implementations are possible and contemplated.

For example, a list of events may be displayed along with a priority level, alert severity, alert source, tags, sources, or other data. In some implementations, the interface 1000 may allow the events to be filtered by type (e.g., metric, forecast, network, outlier, etc.), which may be associated with tags on alerts generated by a CNS 412, CDR server(s) 116 (e.g., by an IoT core 422, cloud computing service 424, analytics server 406, CDR management service 466, etc.). Similarly, the events (e.g., events, faults, or alerts) may be filtered by creator, creator handle, tag, category, responsible team/stakeholder, scope, or other types of data. Additionally, each line, status indicator, or other field for the events in the interface 1000 may automatically be changed based on the status of the event, whether the event is an alert, alert severity level, or response status.

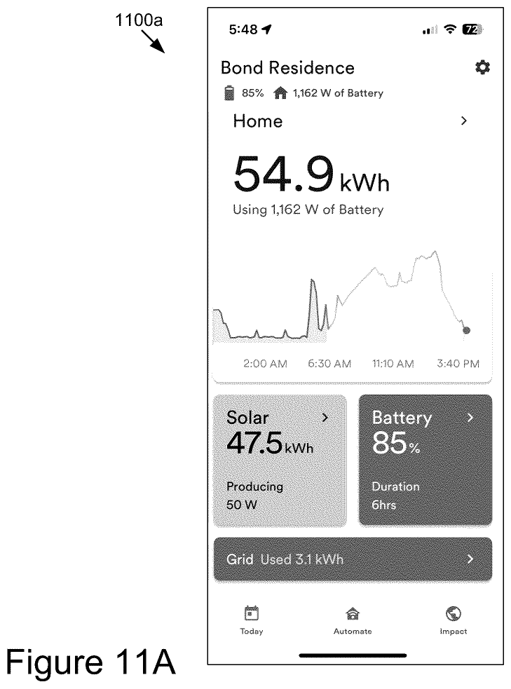

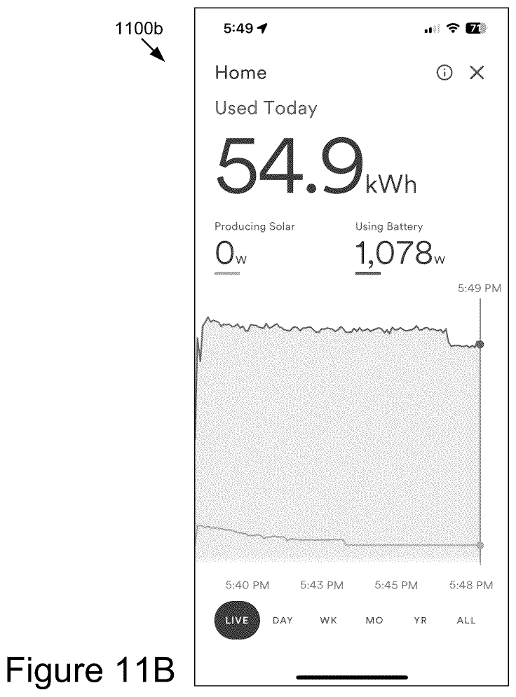

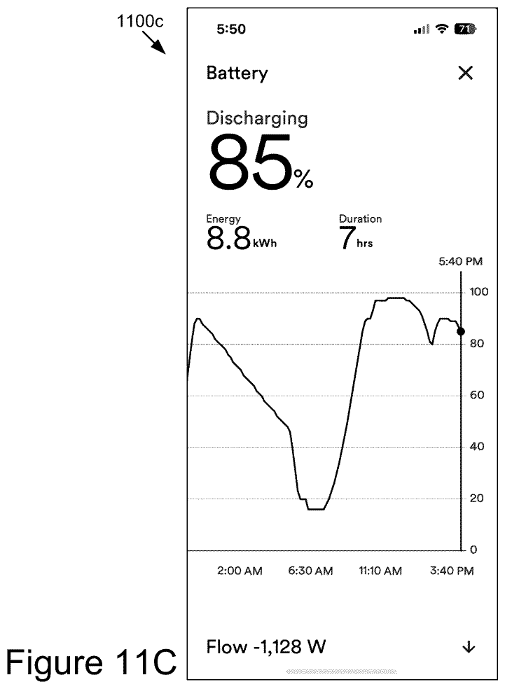

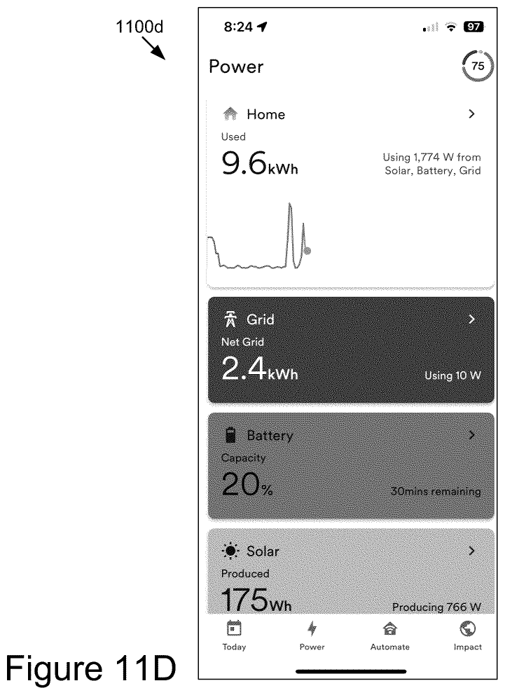

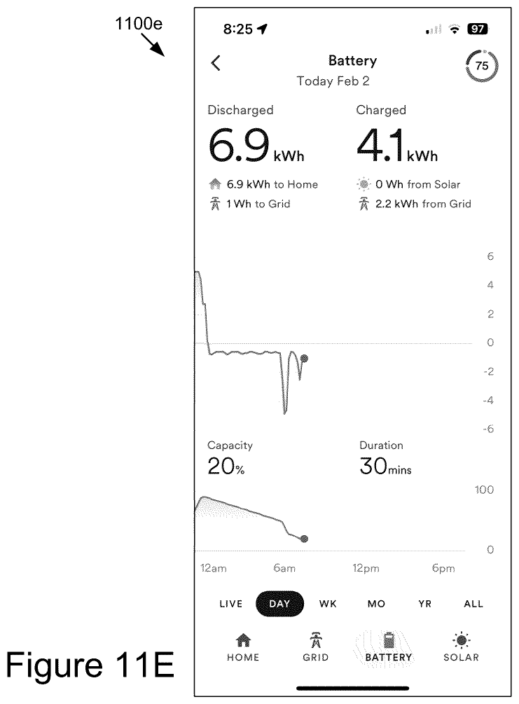

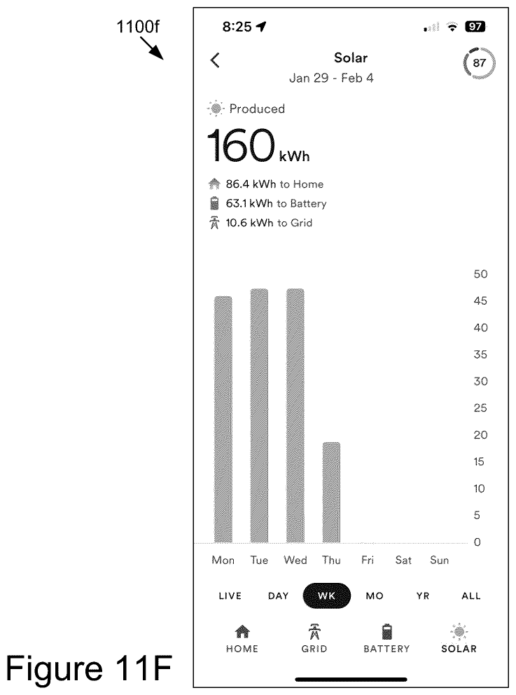

FIGS. 11A-11F illustrate example mobile graphical user interfaces 1100a-1100f that may be displayed to a stakeholder, such as an administrator or customer. The example mobile interfaces 1100a-1100f may reduce the data described above into a format that is viewable on a mobile device with limited display or inputs. For instance, the interfaces 1100a-1100f show graphs of energy use, solar production, battery capacity and state, consumption from the grid, etc. The mobile interfaces 1100a-1100f, like the other interfaces described above, may be selected and enlarged, the various types of data may be overlaid, and data points may be selected to view their values. It should be noted that other implementations and features are possible and contemplated.

For example, as described above, a user application 172 may query data from a CDR server(s) 116, such as from a backend database 426, 458, or 460, analytics server 406, CDR management service 466, or another device. The user application 172 may select the data based on a login, authorization, permissions, preferences, or roles of the user. For instance, if the user is an administrator or engineer, alert, telemetry, or diagnostic data may be displayed. If the user is a customer, the user application 172 may automatically retrieve and display information associated with that user's account, such as data for their own node/ESU 402 at their residence.

FIG. 11A illustrates an example graphical user interface 1100a, which may be displayed on a client device. The example interface 1100a may display solar production (current or total), battery percentage and health, status of moving power to/from the grid, or other details. These values may be shown in graphical widgets in text and/or graph formats.

FIG. 11B illustrates an example graphical user interface 1100b showing kilowatt hours used at a given node over a defined time period (a day) including how much is received from solar, battery, etc. FIG. 11C illustrates an example graphical user interface 1100c displaying a charge percentage of a battery 416, whether it is charging or discharging, an available energy, a projected battery life, or other data. FIG. 11D illustrates an example graphical user interface 1100d displaying graphical elements indicating power current and/or total power usage from various sources, such as from the grid, battery 416, solar, and/or other power sources. The interface 1100d may automatically adjust the color or shade of each graphical element to indicate how much power is being used, stored, or generated from each source. FIG. 11E illustrates an example graphical user interface 1100e displaying an amount charged or discharged total over a selected time period (live, day, week, month, year, all, etc.) and how much was charged or discharged at various times (e.g., in a line graph) from a selected device. For instance, the interface 1100e may include tabs or icons from which a home screen, grid screen, battery usage display, solar display, etc., may be selected. FIG. 11F illustrates an example graphical user interface 1100f displaying a solar tab of an example user application 172 in which solar power production and routing (e.g., whether the power was used, stored in a battery 416, transferred to a grid, etc.) is illustrated (e.g., in textual and date-linked bar chart formats).

For instance, as data is gathered from a CNS 412 or other computing devices coupled with the inverter 414, battery 416, flywheel, or sensors (e.g., current sensors) at a node, it may be processed as event data and stored in the database(s) (e.g., 426, 458, and 460), as discussed above. For instance, as described in reference to FIGS. 4A and 4B, if event data is not classified as a fault (or if it is also classified as a fault), it may be processed and routed to the database(s) for review by users (e.g., using a user application 172).

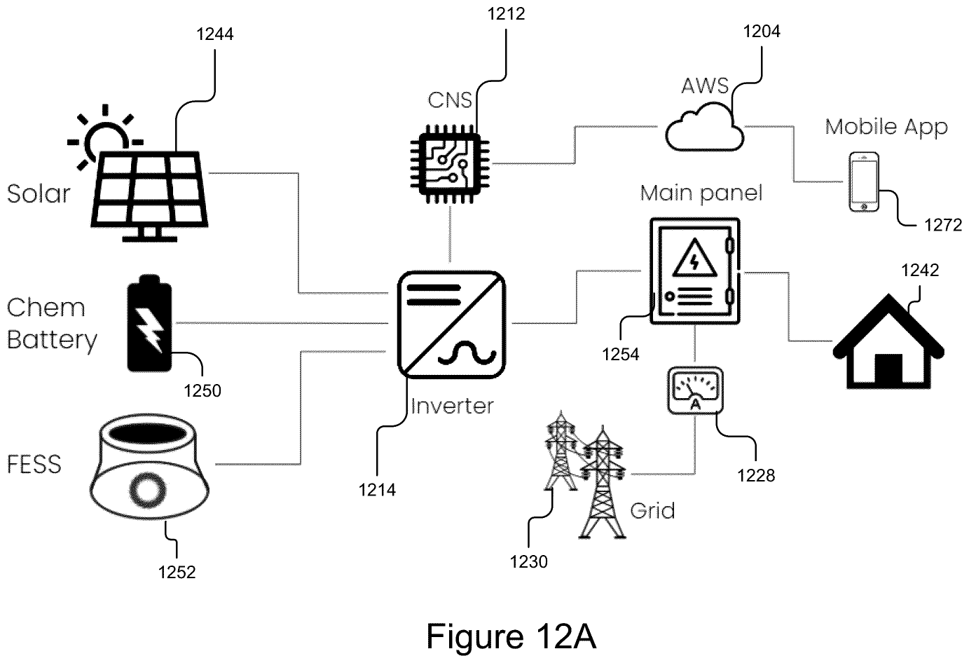

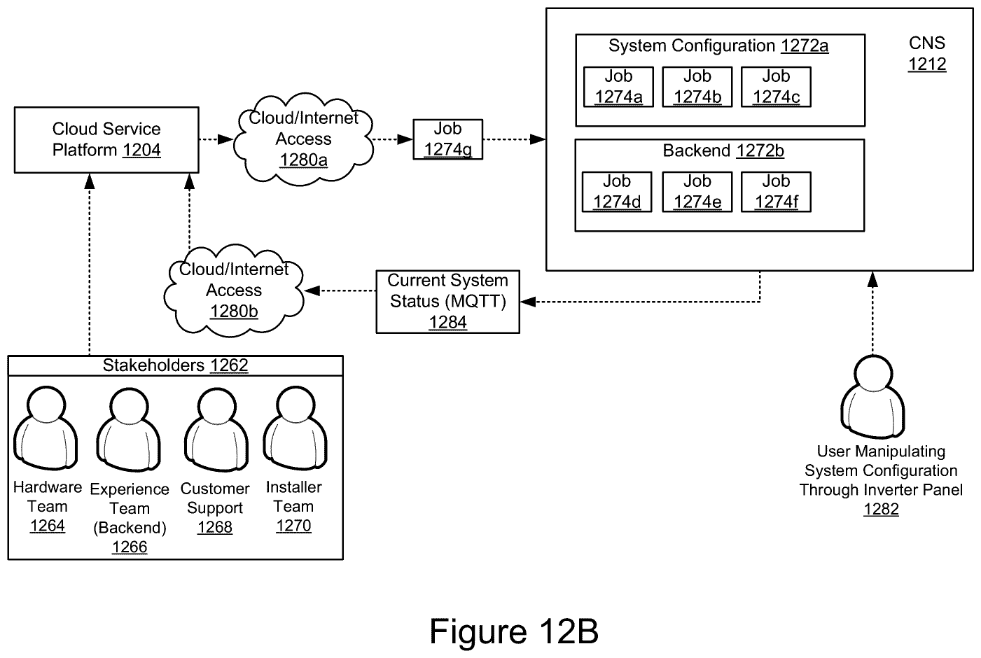

FIGS. 12A and 12B illustrate example environments in which the CNS 1212 may be used, such as its local and remote connections. For example, the CNS 1212 may be a component of an overall system of local and remote computers and hardware that are interconnected to provide external access, local error detection, data collection, and redundancy, among other functionalities. This arrangement provides numerous benefits, as noted elsewhere herein.

For example, FIG. 12A illustrates a central nervous system (CNS) 1212 which may form all or part of the brain or controller of an ESU Station and is designed to report, regulate, and monitor renewable energy generation, storage, and consumption empowering a user to make smarter decisions in their energy consumption. The example CNS 1212 also makes automation and orchestration possible for an ESU, which results in more decarbonization and higher efficiency score (e.g., an example rating for carbon reduction through clean-energy usage) for the user. The example diagram of FIG. 12A may include an illustration of a high-level structure of ESU station. The CNS 1212 described may be an example of the CNS 412 described elsewhere herein. Similarly, examples of the platform 1204, inverter 1214, power meter 1228, grid 1230, premises 1242, solar system 1244, main panel 1254, chemical battery 1250, FESS 1252, mobile application 1272, etc., are also illustrated, which may be example implementations of similar components described herein.

For example, each home or other premises 1242 that has power through an electrical grid 1230 may have a utility meter 1228 and a main panel 1254. The main panel 1254 distributes the power to different circuits at the building. A utility meter 1228 measures how much power is used by the house/building 1242, which measurement may be used by a utility company to determine consumption. If the house/building 1242 has local power production and/or storage, such as a solar panel 1244 and/or a battery (e.g., a chemical battery 1250, flywheel 1252, or other battery), an inverter 1214 may be used to convert the DC power from the solar 1244 and/or battery 1250/1252 to AC power which is usable by home 1242. The ESU station may also include a flywheel energy storage system (FESS or MESU) 1252, CNS 1212, and software logic, which can help turn a home into a renewable power station.

As illustrated in the example of FIG. 12A, the CNS 1212 may be communicatively coupled with a server 1204 (e.g., Amazon Web Services™ or AWS™ platform 404, etc.), which may be coupled with one or more other servers or systems and may provide access to data associated with the CNS 1212 by client devices, such as smartphones, personal computers, other servers, or otherwise. The CNS 1212 may be communicatively coupled with the inverter(s) 1214, sensors, and/or other equipment, which may be local with the CNS 1212 at the building/house 1242 or otherwise.

Although other implementations are possible, the CNS 1212 may serve as a bridge or controller communicating between the platform 1204 or other servers and local components, such as an inverter 1214, which may be electrically and/or communicatively coupled with other components. As noted in further detail elsewhere herein, the CNS 1212 or 412 may include various input or output ports, local memory, local processing, etc., that orchestrate interaction and coordination between components, for instance, to provide the functionality described herein.

FIG. 12B illustrates an example interface system overview, which illustrates an example CNS 1212 communicatively coupled with one or more server(s) (e.g., using AWS™), such as the cloud service platform 1204, which may provide information to stakeholders 1262. In some implementations, the CNS 1212 may also allow a user to manipulate the system configuration through an inverter panel or another I/O interface of the CNS 1212. As illustrated in the example, the CNS 1212 may provide information, such as the current system status, through an interface protocol (e.g., MQTT™, a JSON interface, etc.) to the server 1204, which may send data, such as commands, to the CNS 1212. Similarly, the server(s) 1204 may provide data, analytics, and control to one or more external systems, such as to client device(s) operated by hardware teams 1264 that manage local hardware (e.g., CNSs, ESUs, etc.), experience teams 1266 that manage back-end services, customer support teams 1268, installer teams 1270, customers owning local hardware, etc.

In some implementations, the CNS 1212 may include various system configurations 1272a or backend configurations 1272b that may be set and/or include jobs, such as jobs 1274a, 1274b, 1274c, 1274d, 1274e, 1274f, etc., transmitted to the CNS 1212 by the server(s) 1204.

This example mechanism may allow commands to be issued to the CNS 1212 from different stakeholders 1262 for a variety of purposes. With command and control, this variety of control introduces challenges and safety concerns regarding this mechanism, which are addressed by the data flow, hardware, and other features described herein. Due to the unique nature of the chemical and/or flywheel energy storage used with the CNS 1212, these safety concerns may be addressed using the technologies described herein in improved ways. For example, exposing some or all potential configuration options directly outside an inverter profile presents challenges in relation to security and safety. In some implementations, it may be sufficient or insufficient to send single register changes. The logic for safe job implementation may live in the CNS firmware. In some implementations, the Software Bounded Contexts can ask for configuration changes, rather than tell, via jobs (e.g., AWS™ jobs) 1274. Because, if configured improperly, the inverter configuration can cause damage to property or life (e.g., fire hazard, overcharged batteries, etc.), these systems allow safe inverter configuration and management through, for instance, defensive programming in code. For instance, as described herein, the code may be written to be less prone to present or future errors potentially caused by unexpected user inputs/actions thereby reducing the probability that a normal user would accidentally cause unintended operation, for example, as noted below and elsewhere herein.

Accordingly, the CNS hardware, firmware, software, etc., may be subject to various safety checks. Some or all configuration write operations may have a range check (if the value is a number type) to validate the data is within a valid range of the configuration option. In some instances, the CNS 1212 may expose only the configuration options or ESU station options (e.g., modes, etc.) that are required for the use case. This firmware or software limitation may prevent a large attack vector and the possibility of other non-hardware/non-firmware engineers making changes to the configuration before the hardware team has validated the functionality. For example, experiments with the inverter may be done by the hardware and firmware engineers, not by the software engineers for safety and product stability.

Depending on the implementation, some or all configurable options and/or ESU station options may have a hook mechanism to validate the system is in the correct state/mode before the write operation. One example of this scenario is where the inverter has an active fault which would make it dangerous to change to a particular mode. The bounded context that may be responsible for queuing jobs 1274 (e.g., AWS Internet of Things/IoT Jobs) may be register agnostic (e.g., backend will not know the physical register address) to facilitate the abstraction of multiple manufacturers of inverters. The CNS 1212 may handle the conversion of the value to the proper data type (e.g., uint16_t vs int16_t) if needed. Some or all jobs 1274 (e.g., AWS IoT Jobs) may be logged for debugging and validation within the CNS 1212. For example, for all AWS IoT Jobs, CloudWatch™ to Kinesis™ to DataDog™ (e.g., an analytics server 406), additional Job processing logs may be uploaded via Datadog IoT Agent for validation and verification of functionality with the DEBUG all flag.

Accordingly, the example command and control interface/interactions(s) illustrated in FIG. 12B may be designed to meet many needs across the organization from different stakeholders 1262, which presents certain challenges to making the design simple and safe. A job type may describe the origination or the stakeholder 1262 of a group of jobs 1274. The cloud service platform 1204 and/or the CNS 1212 may require each originator (e.g., of the stakeholders 1262) of the request to assume the following environment for the interface design: any job 1274 sent can fail at any time due to the non-deterministic nature of the “Internet” pipeline, although other implementations are possible. Different customers have different ISP providers, networking equipment, and types of connections (e.g., satellite (high latency) vs cable vs fiber). Accordingly, in some implementations, the sequence of jobs 1274 may avoid interdependencies between jobs 1274 to avoid putting the system in an undefined state. For example, the CNS's configuration and logic may avoid decoupling the interface to avoid a scenario where if a single job fails in a sequence of 2-X individual jobs, the system goes into an undefined state, such as by executing jobs 1274 one at a time.

For example, one or more stakeholders 1262 may send a request (e.g., via a client computing device) to the cloud service platform 1204 (e.g., hosted on AWS™), which may process the request, generate logs for analytics (e.g., by a analytics system-not shown), and/or generate/relay a job 1274g via Internet access 1280a to the CNS 1212, for example, at an ESU station at a residence or other premises. The CNS 1212 may process the job 1274g received, for example, based on the stakeholder 1262 identity, thresholds/ranges, or other criteria, as noted above and elsewhere herein to ensure that it is safe, secure, authorized, etc., and the CNS 1212 may store or replace it in the system configuration 1272a or backend configuration 1272b, depending on the job(s) 1274g and the processing.

In some cases, a user 1282 may locally interact with the CNS 1212 to manipulate the system configuration through a CNS 1212 interface and/or inverter panel. Depending on the implementation, the system may perform the same checks as a remote job or configuration change, may require a login, or may otherwise control access or allow more-detailed or less-restrictive configuration changes.

In some implementations, either separately or based on the job 1274g, the CNS 1212 may send a current system status message 1284 (e.g., via Message Queuing Telemetry Transport protocol or MQTT™), for example, through internet access 1280b to the cloud service platform 1204.

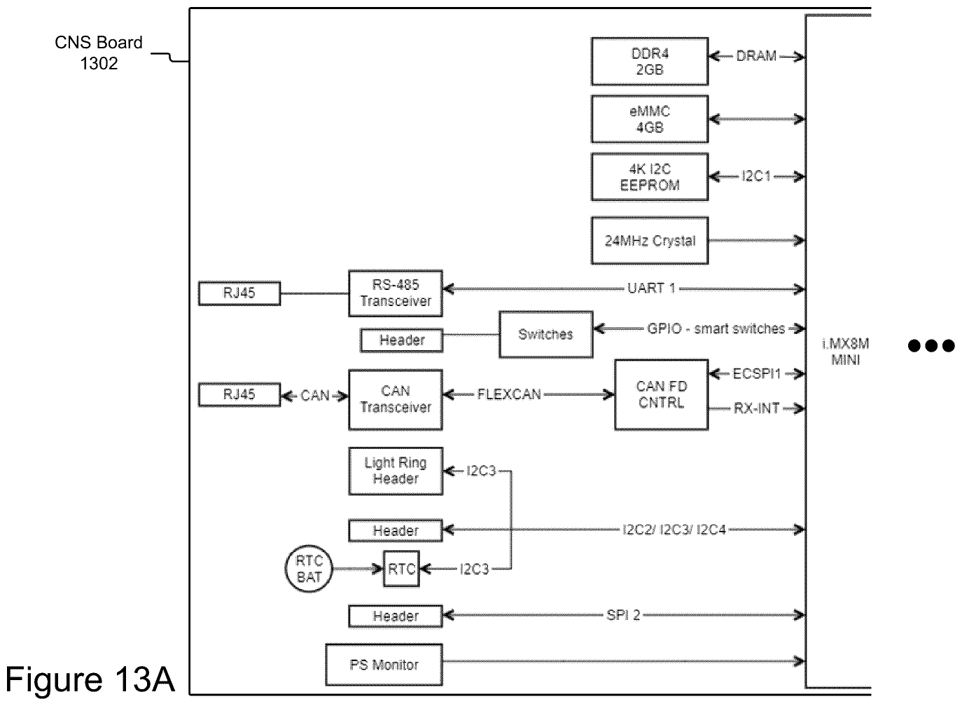

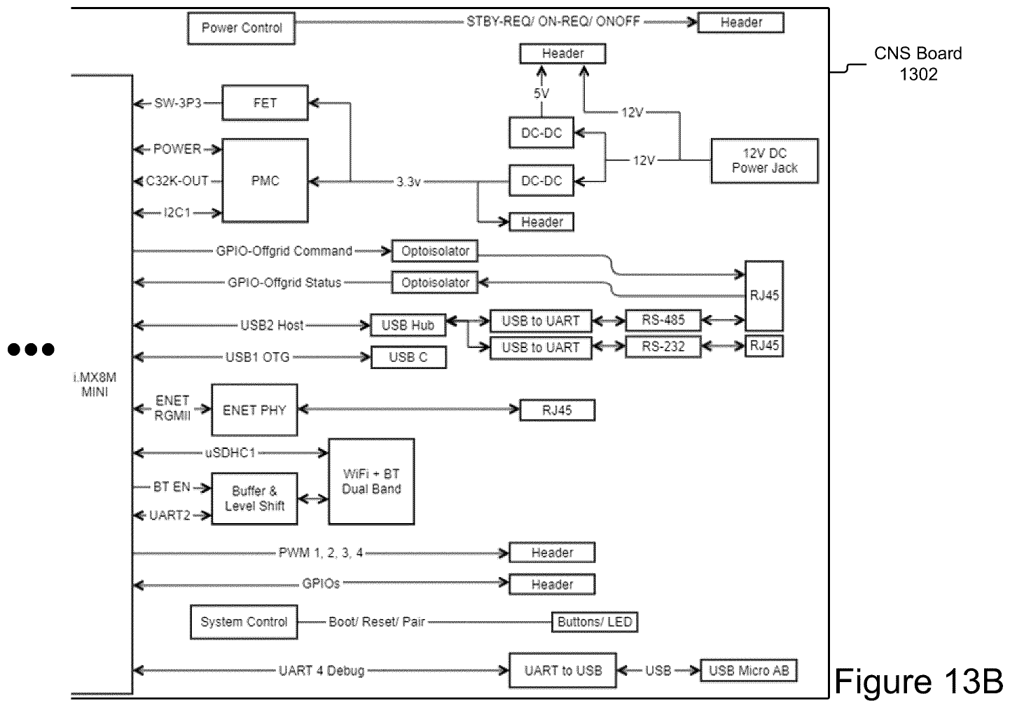

FIGS. 13A and 13B illustrate an example board diagram of a CNS board 1302, which spans FIGS. 13A and 13B (e.g., linked by the example application processor—i.MX8M MINI™), which may provide local control, as described elsewhere herein. In some implementations, the CNS 412 or 1212 (referred to as 1212 in reference to FIGS. 13A and 13B) may include a CPU board 1302, which is represented by the example components in the block diagram of FIGS. 13A and 13B.

The CNS 1212 may be configured to connect to the Internet through Wi-Fi or ethernet/wiredly and/or can pair to a mobile app through Bluetooth. For instance, example transceivers are illustrated being coupled with the application processor for communicating wirelessly or wiredly (e.g., via one or more Ethernet or other ports, general purpose input/output—GPIO—switches, serial or parallel ports, etc., as shown in FIG. 13A). The CNS board 1302 may also have a CAN (Controller Area Network) transceiver for communicating with various components of the ESU station.

The CNS 1212 may use interfaces, such as those noted above, to collect information regarding the power generated by solar panels, energy stored in a chemical battery and/or FESS, energy used from grid and the partial or entire energy consumption of the home. This information may be sent to a server (e.g., the cloud service platform 1204) to provide input regarding the status or health of the system, and its performance and other information or analytics may be displayed in mobile app to give the user an insight into what's happening in their home.

The CNS 1212 may use the interfaces or communication ports (e.g., an Ethernet transceiver and RJ45 port, Wi-Fi chip, etc.) to report the faults that might occur in the system. As noted elsewhere herein, if a fault is reported, it may indicate a problem at that moment in time when the message was sent or at a timestamp. The CNS 1212 may also report a severity of a fault, which can be minor, major, or catastrophic, for instance, although other quantities and categorizations of fault levels are possible, (e.g., Alpha, Bravo, Charlie, Delta, and Echo, or otherwise), which are described elsewhere herein. It should be noted that these are provided as examples and that other implementations are possible and contemplated herein. The processor and logic of the CNS 1212 may automatically clear minor faults, but they may affect telemetry messages. Depending on the implementation, the CNS 1212 may not clear major faults but may require a cycling of power and/or restarting the unit to attempt a remedy. The CNS 1212 may transmit documentation to indicate a course of action for a given fault. The CNS 1212 may also be configured to do remote resetting of the system without user intervention. Catastrophic faults may indicate physical damage to the hardware and may require technician intervention. Faults categorized by the CNS 1212 as the category “major” can be “upgraded” to this status if resetting and/or cycling power does not clear the fault. The CNS 1212 may be beneficially configured to report faults from an inverter, chemical battery, FESS, and/or current sensors. The activity of CNS 1212 may be monitored online (e.g., by a cloud service) to make sure it is operating within defined parameters, as noted elsewhere herein.

The CNS 1212 may provide an option to command the inverter and the FESS based on a message received from an external computing device. For example, the MESU/ESU station may have several modes of operation, such as: sunny, cloudy, storm watch, and off-grid, etc. These modes are automatically set to provide the user with the most use of their storage solution and help them use as much renewable energy as possible. The implementation of the CNS 1212, as described herein, allows the use of modes, which was not previously possible. For example, the server may transmit an instruction telling the CNS 1212 to enter a specific mode. The CNS 1212 may then command the inverter to change the mode or use off-grid storage and hardware to take the home off-grid.

The CNS 1212 may also provide all the solar generation information to the server and, in case of excess generation, the system may orchestrate devices to use the excess solar.

In some implementations, the CNS 1212 may communicate with smart circuit breakers to control the smart breakers to add/or remove loads, which service may be used to disconnect large loads when off-grid or connect them through orchestration when there is excess renewable energy.

In addition to the example application processor (e.g., an i.MX8M MINI), CAN and Ethernet transceivers, smart switches, and other headers or ports, the CNS board 1302 may include a power supply and monitor, a light controller, a clock, read only memory, flash storage, random access memory, or other components. Similarly, the CNS board 1302 may include one or more headers for controlling or communicating relay switches or other components, such as a pulse width modulation (PWM) header, a general purpose input/output (GPIO) header, or otherwise. For instance, the CNS board 1302 may receive low voltage DC power and/or send a signal current (e.g., to a relay switch, etc.) via a low voltage (e.g., 5 volts, 12 volts, etc.) port/header, which control signal may be used to control a higher voltage (e.g., 120 volts, 240 volts, or 480 volts) contactor, relay switch, load, etc.

FIGS. 13A and 13B also illustrate various example components coupled with the application processor, such as a power supply switch or switching regulator, clock input or output, power management controller, and other components, which may be coupled with a power jack and other components. It may also include a power controller, power switch, or other control device.

One or more optoisolators may provide internal or external communications between the application processor or otherwise to internal or external components. The CNS board 1302 may include ethernet physical layers, a Wi-Fi™ radio, other general purpose or dedicated input/output interfaces. Similarly, the CNS board 1302 may include one or more universal serial bus (USB) controllers and ports for communicating, for example, with an inverter, sensor, or other components of an ESU. In some instances, one of these or other interfaces may be used to provide remote or local configuration jobs or messages, as noted elsewhere herein. The CNS board 1302 may include a UART (Universal Asynchronous Receiver/Transmitter) 4 debug port for debugging.

As illustrated, the CNS board 1302 may include logic stored on memory, one or more processors, and various communication interfaces, which may allow remote configuration, local configuration, debugging, monitoring various sensors, communicating with various components, such as an inverter or battery controllers, motor controllers, or other devices. The CNS board 1302 may include, communicate with, or control lights, switches, or other devices.

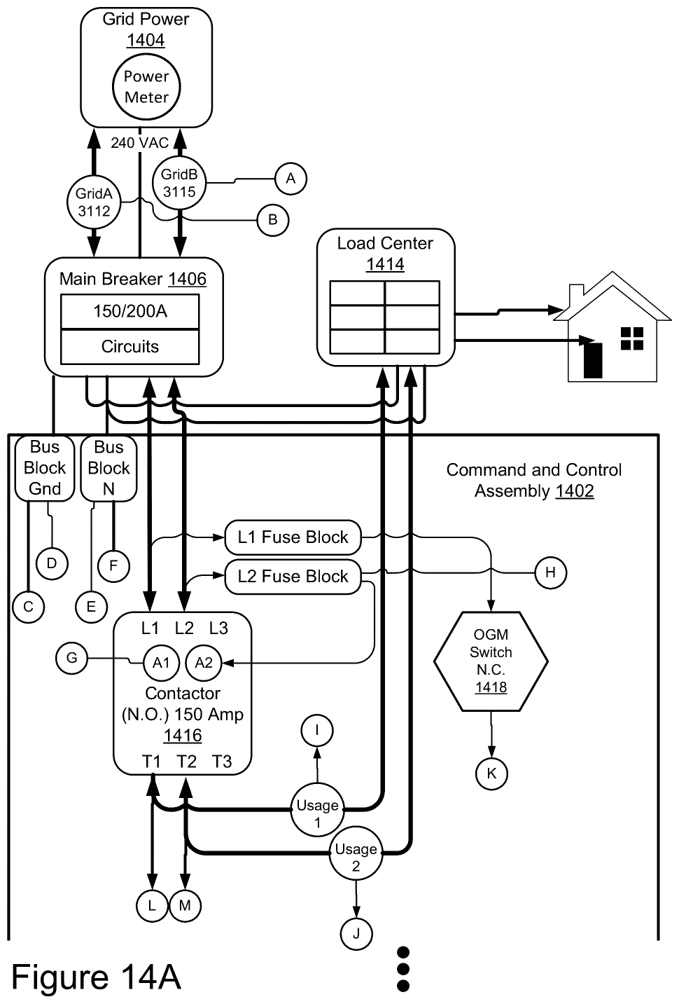

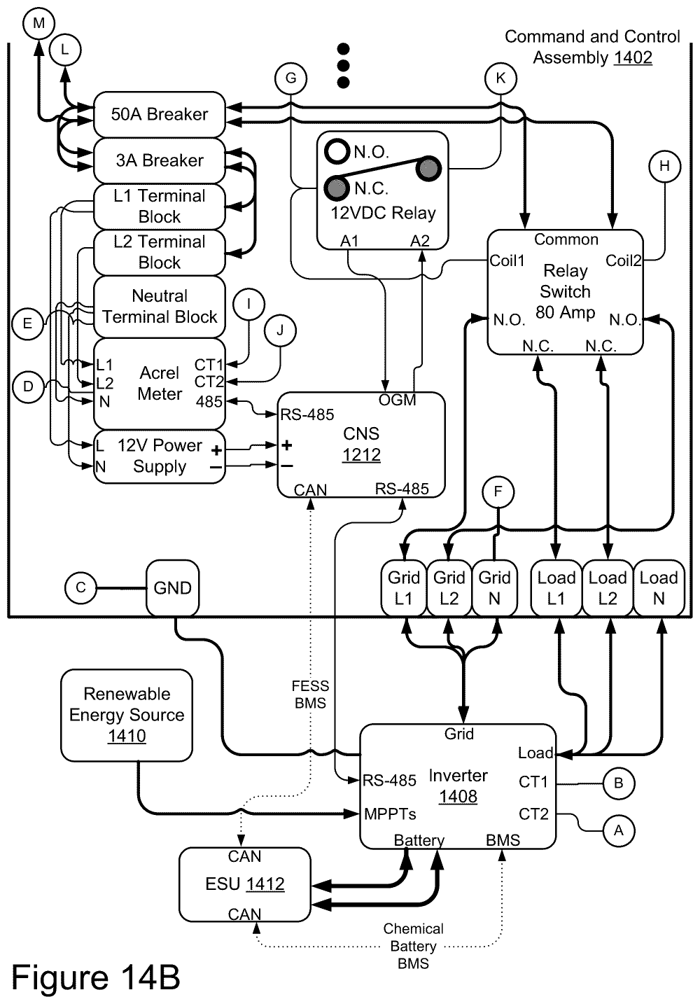

FIGS. 14A, 14B, 15, and 16 illustrate example diagrams of example command-and-control assemblies 1402 (also referred to as control systems), which show example components including a CNS 1212, electrical circuits, and context, such as in an ESU station. For example, these figures illustrate alternative implementations, but it should be noted that, in some implementations, their components and features may be combined or exchanged. Furthermore, it should be noted that other or additional layouts, configurations, features, and components may be used without departing from the scope of this disclosure. For example, the assembly may be coupled with one or more external grids, loads, breakers, power sources, inverters, energy storage units, etc. A command-and-control assembly 1402 may include meters, breakers, and relays arranged in a way to provide improved efficiency and control, while reducing the cost of the assembly. The assembly may include a CNS 1212 coupled with the power supply, meters, sensors, relays, switches, and other devices. For instance, the CNS 1212 may be communicatively coupled with an inverter, an ESS of a FESS, and an external server. In the figures, the components and features may correspond to the other examples and implementations described throughout this disclosure, for example, a CNS 1212 may correspond to a CNS 412, an inverter 1408 may correspond to an inverter 414, etc.

FIGS. 14-16 include various terms, which may be standardized electrical engineering terms, some of which are abbreviated in the figures for clarity. For instance, the figures may indicate “Gnd” for ground, “N” for neutral, “N.O.” for normally open, “N.C.” for normally closed, “L” for line or input, “T” for terminal or output, “DC” for direct current, “AC” for alternating current, “V” for volt, “A” for amp, “CT” for current transformer, “MPPT” for maximum power point tracking, “Inv” for inverter, “Aux” for auxiliary, and “AWG” for American Wire Gauge. “RJ-45”, “RS-485”, and CAT6 are standard connections, though it should be noted that other connectors or communication standards may be used. Other terms are also defined below, such as “BMS” for battery management system, “OGM” for off-grid mode, “ESU” for energy storage unit, “FESS” for flywheel energy storage system, etc., as noted elsewhere herein. Because the diagrams extend over multiple pages, small circular page links are provided to link lines. Some meters or sensors may also be shown as circles.

For example, FIGS. 14A and 14B illustrate an example command-and-control assembly 1402, according to some implementations. As illustrated in the example, grid power 1404 may come into a main breaker 1406, which is coupled with a command-and-control assembly 1402. In some instances, command-and-control assembly 1402 may route power from an inverter 1408 to the home and, if the grid power goes out, automatically switches the power source for the home to renewable energy 1410 and/or backup power from an ESU 1412. For example, an inverter 1408 (e.g., hybrid inverter) may couple with solar panels, a battery backup, a flywheel motor, etc., to convert between DC and AC current. The command-and-control assembly 1402 is named herein as an example, and may be referred to using alternative names, such as the Torus Off Grid Switch (TOGS) or otherwise.

While a hybrid inverter 1408 may be used, off-grid loads may be limited to the power rating/capacity of the inverter 1408 (e.g., 8000 watts). Accordingly, in some implementations, the command-and-control device/assembly 1402 may route power from the grid 1404 to the house regardless of the inverter capacity and, for instance, up to the rating of the house's service panel (e.g., 150, 200, etc., amps), which may represent a load center 1414. The power may be routed from the main breaker 1406 to an electrical contactor 1416, which routes it to the house (e.g., to the service/breaker panel of the house) or other load. In some instances, the CNS 1212 or other component may be communicatively coupled to smart breakers (e.g., an Acrel™ meter) or a smart service panel to adjust load downstream. It should be noted that although an Acrel™ meter is illustrated, for example, in FIG. 14B, other types may be used, or the meter may be omitted from the design at this point, for example, by using readings directly from the inverter 1408, other meters, or other sensors.

Similarly, power may be routed to the contactor 1416 from the inverter 1408 to the house 1414 and/or to the external grid 1404 depending on a mode or setting defined by the CNS 1212. For example, when a grid outage is detected, a relay/switch (e.g., an 80-amp relay) may flip from an open to a closed position, or otherwise depending on the configuration, so that the inverter 1408 may power the house and/or some of its loads. In some implementations, the CNS 1212 or another device may control smart circuit breakers, switches, appliances, EV chargers, or other devices to increase or decrease the load(s) of the house.

In some implementations, the configuration of the command-and-control assembly 1402 may use low-cost switches, relays, breakers, meters, and/or other components to efficiently change modes, based on control signals by the CNS 1212.

In some implementations, the command-and-control assembly(ies) 1402 may have a physical, button 1418 that can be pressed to flip a relay or other switch to an open position, which may serve as an emergency button or may actuate an off-grid mode (OGM). In some implementations, the button 1418 may be used to decouple the house from the grid 1404 and run off renewable 1410 (e.g., solar) and/or stored 1412 (e.g., in an ESU) power. This switch 1418 may additionally or alternatively be controlled based on a signal from the CNS 1212 (e.g., coupled to the switch 1418 via a relay) based on instructions received by the CNS 1212 via a server (e.g., based on an instruction from a mobile application). For example, the CNS 1212 may change the “mode” of the assembly 1402 by flipping the switch via a coupled electrical relay input contact that causes an internal contact to close, although other devices (e.g., solid state relay switches, etc.) may be used.

For example, the command-and-control assembly 1402 may include one or more breakers, terminals, meters, and power supplies that may provide power to the CNS 1212, provide power readings, etc., and the CNS 1212 may control a low-voltage relay that triggers a higher power relay switch, though other implementations are possible. The high-voltage relay may, in turn cause power to be routed to/from an inverter 1408 or otherwise. Similarly, the CNS 1212 may be communicatively coupled with the inverter(s) 1408 to send and receive information to/from it, as noted elsewhere herein. In some instances, separate inverters 1408 may be used for an ESU 1412, renewable energy source 1410, generator, etc. Additionally, while the CNS 1212 is illustrated as being communicatively connected with the energy source 1410 and ESU 1412 via the inverter(s) 1408, it may additionally or alternatively be directly connected.

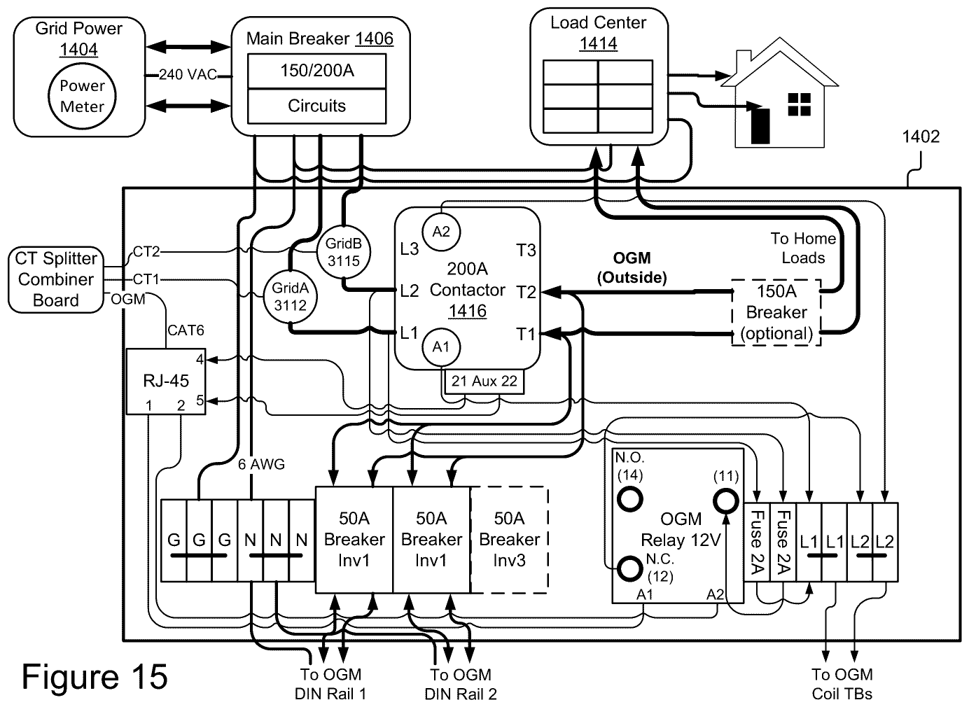

FIG. 15 illustrates another example implementation of a command-and-control system 1402. In the illustrated example, a CNS 1212 may be omitted, not shown in the illustration, or it may be external to the command-and-control system 1402. The example of FIG. 15 may include some or all of the components described above, for example, in reference to FIGS. 14A-14B. For example, a current transformer splitter combiner board may serve as or include the CNS 1212 and may communicate with various components of the system to actuate a low voltage relay switch and/or a high-voltage contactor (directly or via the low voltage switch), which may control current through various switches and breakers, as illustrated in the example.

FIG. 15 also illustrates various ground, neutral, and load connections, industrial switches (e.g., GridA and GridB, which may be controlled by the splitter combiner board or CNS 1212), fuses, and other components, which route current between the grid 1404, ESU(s), and/or energy generator(s) (e.g., coupled via one or more switches and/or DIN rails), which are illustrated in the example.

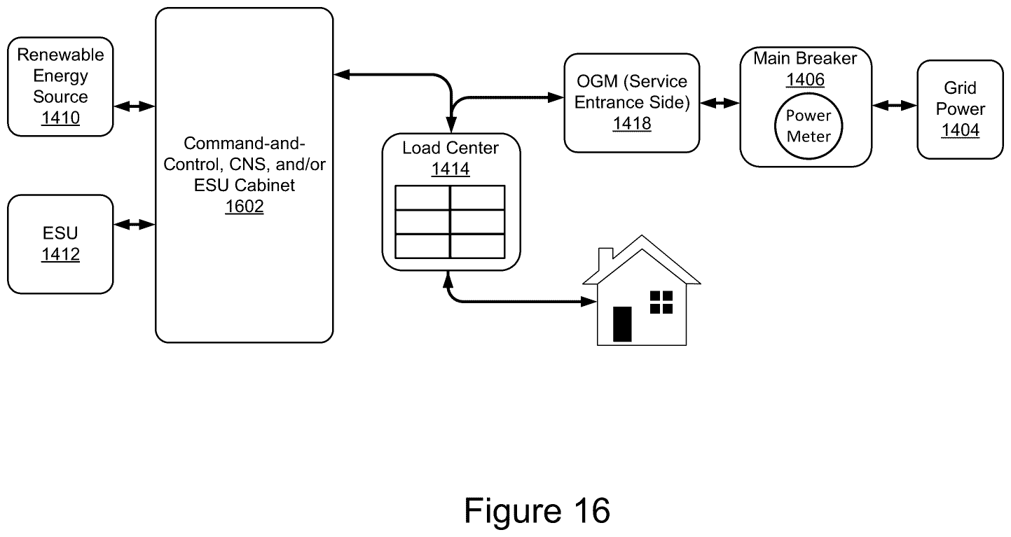

FIG. 16 illustrates another example implementation of a command-and-control system and context. In the illustrated example, a command-and-control system, CNS, and/or components of an ESU may be located in a cabinet 1602 or device and may electrically and/or communicatively coupled with a renewable energy source 1410 and/or ESU 1412, as noted above. One or more of these components in the cabinet may control routing and/or route current between the devices 1410 and 1412 and the load center 1414, which may be a premises or a component (e.g., an electrical service panel) of the premises. In some implementations, the grid power 1404 may be coupled with the load center 1414 and/or one or more components of the cabinet 1602 via a main breaker 1406 (e.g., with a power meter) and a service entrance side switch or other component 1418, for example, for decoupling the system from the grid (e.g., in OGM or off-grid mode).

For example, although other implementations are possible, by using a set of switches, breakers, meters, and other components, as illustrated in the example of FIGS. 14A-16, the control of which device is receiving or providing power is simplified along with the cost (e.g., by an order of magnitude, etc., depending on the implementation) and complexity of the system. Furthermore, the example assembly 1402, CNS 1212, and other technology described herein provide functionality that may be performed or controlled locally (e.g., in a single box or otherwise located locally to a load and/or power source), which allows improved functionality while also allowing command and control in ways that improve safety. For instance, by these components being local, the technology may improve safety by providing functionality when there are network connectivity issues and/or with decreased latency over systems that might provide similar functionality over a wide area network or otherwise. For example, the CNS 1212 may be directly coupled to switches, sensors, etc., to process data quickly and locally, but may also be communicatively coupled to a server to improve command, control, and safety capabilities.

The CNS 1212 may gather information from sensors, system states, etc., from the command-and-control assembly 1402 and/or coupled devices and transmit data and/or analytics to a server, which provides external control to client devices, applications, or web-interfaces. Accordingly, a user can view system health and state and control mode, diagnostics, etc., as discussed herein. Thereby, a single command sent to the CNS 1212 can cause multiple operations to be performed thereby setting diverse modes. For example, the CNS 1212 may control whether or how much power is flowing between a power grid 1404 (e.g., an electrical utility grid), load(s) 1414 (e.g., house), power source (e.g., solar panels 1410), chemical battery, flywheel 1412, or otherwise.

It should be noted that although a single inverter 1408 is illustrated being coupled with the command-and-control assembly 1402 (and/or CNS 1212) and energy source(s)/backup(s), multiple separate inverters may be used. For instance, the assembly 1402 may be coupled with an inverter of a solar panel, an inverter of a chemical battery, and/or an inverter of a flywheel energy storage unit.

It should be noted that although certain connections and protocols are illustrated in FIGS. 14A-16, the CNS 1212 and/or command-and-control assembly 1402 may use various communication protocols and connection types. The CNS 1212 may use multiple communication protocols, for example, it may use a first protocol to connect to an inverter 1408 and another to connect with a CPU of a FESS (e.g., where a separate processor/controller controls a flywheel energy storage system). Accordingly, it may gather information from the inverter(s) 1408 in terms of how much solar power is generated, how much storage energy is stored in the energy storage unit 1412, the speed of a flywheel, temperature, other sensor data, a status (e.g., safe mode, etc.) of an ESU 1412 or other component, or other data.

The CNS 1212 may thereby monitor the safety of the entire command-and-control system 1402 regarding the generation, storage, and use of power, which safety data may be sent to a server and application, which data may be accessed by a user and/or stakeholder, as described elsewhere herein. As noted elsewhere herein, this data may also improve emergency response. For example, the CNS 1212 may shut the ESU 1412 off, disconnect various components or flip switches, spin down a flywheel to a stop or a defined speed, or otherwise.

In some implementations, the CNS 1212, either directly or via the server/cloud, may use various APIs to communicate with other services, such as with a smart thermostat, smart refrigerator, smart EV charger, or other device. For example, the data from the CNS 1212 may be used to increase or decrease the temperature of the house at a certain time to use excess power, or it may automatically charge (or defer charging) an EV based on an excess or decrease in power generation or availability. Accordingly, the CNS 1212 or data therefrom may smooth power usage across the house and/or overall grid.

Example modes of the command-and-control assembly 1402 (e.g., set by the CNS 1212) may include Peak Shift (e.g., where a peak demand and/or production are offset forward or backward in time based on a grid, house, or other needs), Peak Shave (shaving peak demand or production by dispensing or storing energy), Off Grid (e.g., decoupling the load from the electrical grid and using solar and/or ESU power), or other modes.

In some implementations, the CNS 1212 may automatically determine, based on a setting or communication with a server, a time when the cleanest energy is being produced by the grid 1404. For example, when many solar panels are producing excess power in the afternoon, less coal at a connected coal burning power plant may be used, therefore the electrical grid/production is cleaner. In such situations, the CNS 1212 may set the command-and-control assembly 1402 in a power consuming or storing state (e.g., by consuming additional load or storing more power in a flywheel or chemical battery). The CNS 1212 may then use that stored energy to supply power to the load during instances when renewable energy is reduced (e.g., where additional coal or natural gas is being used, such as at nighttime or on a cloudy day). In other instances, the CNS 1212 may set a mode where it stores excess energy at a peak solar production or clean energy time period and then dumps the energy more quickly into the load to, for example, charge an electric vehicle.

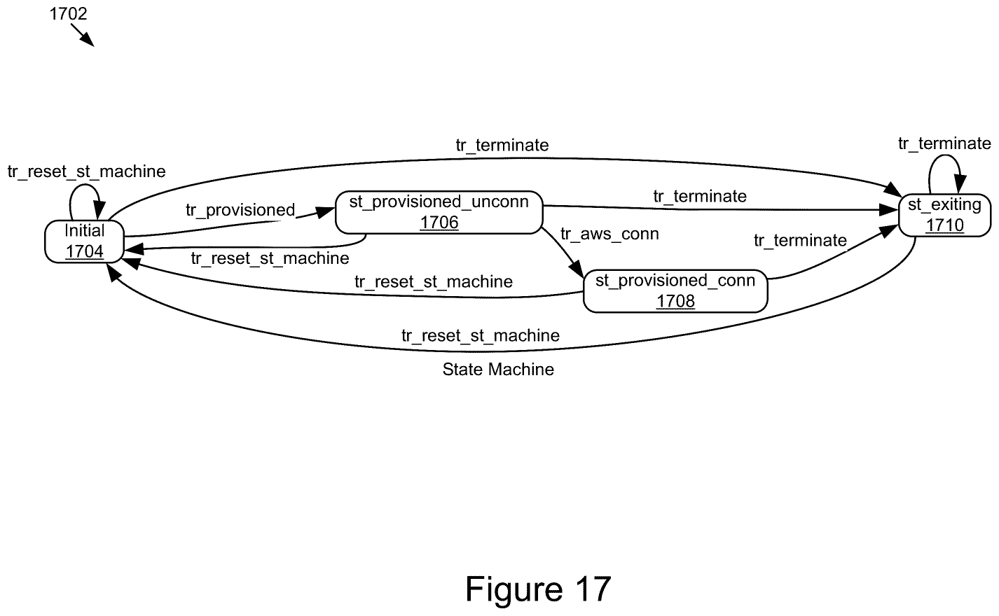

FIG. 17 illustrates an example state machine diagram 1702 showing a state machine that may be used with a CNS 1212 and/or command-and-control assembly 1402, for example, to provide a containerized manager. The state machine illustrates transitions in states between an initial state 1704, a provisioned unconnected state 1706, a provisioned connected state 1708, and an exiting state 1710. Various conditions may be used to determine state transitions, whether provisioning, terminating, resetting, or connecting, for example. In some implementations, the CNS 1212 may poll meter, sensor, inverter, or other data; provision and connect to a backend server (e.g., AWS™); read and report faults; support multiple inverters; support CNS board architecture; etc.

As described elsewhere herein, the CNS 1212, command-and-control assembly 1402, and/or other components may provide a fault manager that detects abnormalities and keeps an active record of some or all active abnormalities within the system. The CNS 1212 may transition between various states, such as monitoring, detecting errors, taking local action, and reporting status, action, or results, for example. In some instances, the CNS, FESS, inverter, and/or smart meter may each cycle through monitoring, detecting, acting, reporting, etc., and the reported data may be routed to an external server for fault or alert detection via the CNS. Accordingly, safe operation may be maintained and determined locally without external intervention while also allowing visibility to external systems. Similarly, in some implementations, the monitoring and detection steps may be performed only locally instead of remotely to prevent duplication of tasks and increase system cohesion (e.g., avoiding fragmentation of how faults are detected and reported).

As noted elsewhere herein, the ESU station may use a fault MQTT messaging system to report issues from internal and external hardware devices (e.g., FESS, inverter, smart meter, etc.), which allows centralized fault monitoring.

Because Internet connectivity may be intermittent and debugging or certain fault messages may be queued (either locally or via a network access point) awaiting transmission and acknowledgement from a remote server (e.g., the cloud service platform 1204), fault determination may be delayed or data loss may be incurred, for example, if exceeding available memory. Accordingly, in some implementations, the CNS 1212 may locally identify faults or alerts by differentiating between debugging or troubleshooting messages and those that require attention or action.

In the foregoing description, for purposes of explanation, numerous specific details are set forth in order to provide a thorough understanding of the technology. It will be apparent, however, that the technology described herein can be practiced without these specific details.

Reference in the specification to “one implementation”, “an implementation”, “some implementations”, or “other implementations” means that a particular feature, structure, or characteristic described in connection with the implementation is included in at least one implementation of the disclosure. The appearances of the term “implementation” or “implementations” in various places in the specification are not necessarily all referring to the same implementation.

In addition, it should be understood and appreciated that variations, combinations, and equivalents of the specific implementations, implementations, and examples may exist, are contemplated, and are encompassed hereby. The invention should therefore not be limited by the above-described implementations, implementations, and examples, but by all implementations, implementations, and examples, and other equivalents within the scope and spirit of the invention as claimed.

What is claimed is:

1. A system comprising:
an energy storage unit including:
a battery storing energy mechanically or chemically; and
an inverter coupled with the battery and converting direct current from the battery to alternating current for use by one or more loads; and
a control system coupled with one or more power sources, the energy storage unit, and the one or more loads, the control system including:
one or more electrical circuits electrically coupling one or more electrical switches that route current between the one or more power sources and the one or more loads, the one or more power sources including the inverter; and
a controller communicatively coupled with the inverter and the one or more electrical switches.

2. The system of claim 1, wherein:
the one or more electrical circuits electrically couple one or more circuit breakers, one or more power meters, and the one or more electrical switches, the one or more electrical switches including one or more relay switches that switch the one or more power sources between a utility grid and the energy storage unit.

3. The system of claim 2, wherein:
the energy storage unit includes a flywheel that mechanically stores energy and provides current to the one or more loads using a motor and the inverter based on local control by the controller, the controller communicating with the inverter and the one or more relay switches to route the current between the energy storage unit and the one or more loads.

4. The system of claim 1, wherein:
the controller is communicatively coupled with the inverter and the one or more electrical switches, the controller communicates with the inverter and a remote server to determine a mode and actuates the one or more electrical switches based on the mode to route power from the one or more power sources.

5. The system of claim 1, wherein the controller includes:
one or more processors coupled with a first communication port for communicating with the inverter, a second communication port for communicating with a remote server, and one or more electrical ports for actuating the one or more electrical switches.

6. The system of claim 5, wherein:
the one or more processors monitor data received from the inverter and a meter, process the monitored data, locally determine a fault, perform a local action based on the fault, and transmit fault data to the remote server.

7. The system of claim 1, wherein:
the controller is communicatively coupled with the energy storage unit via a controller area network to monitor a status of the energy storage unit; and
the controller is communicatively coupled with the inverter to monitor a status of one or more solar panels.

8. The system of claim 7, wherein:
the controller is communicatively coupled with a twelve-volt relay switch that is coupled with one or more of an electrical contactor and a second relay switch, the twelve-volt relay switch being configured to control one or more of the second relay switch and the electrical contactor.

9. The system of claim 1, wherein:
the controller is communicatively coupled with a remote server to receive a job from the remote server, and the controller verifies the job against a defined threshold prior to performing a configuration of the system based on the job.

10. The system of claim 1, wherein:
the control system is electrically coupled with a utility grid, the one or more loads, and the energy storage unit;
the control system includes a central nervous system board, a relay switch controlled by the central nervous system board, and an electrical contactor controlled by the relay switch, the central nervous system board including the controller; and
the control system, using the central nervous system board, controls the one or more electrical switches to route power among the utility grid, the one or more loads, and the energy storage unit.

11. The system of claim 10, wherein the central nervous system board includes:
an application processor, a first port communicatively coupling the application processor with a smart power meter, a second port communicatively coupling the application processor with the inverter, a third port communicatively coupling the application processor with the one or more electrical switches, and a fourth port communicatively coupling the application processor with a remote server.

12. The system of claim 1, wherein the controller includes:
the controller is coupled with a utility grid power source via an electrical contactor, the electrical contactor switching current between the utility grid power source and the inverter.

13. The control system of claim 12, wherein:
the electrical contactor is electrically coupled with the inverter via an electrical relay switch.

14. The system of claim 13, wherein:
the controller controls one or more of the electrical contractor and the electrical relay switch via a second electrical relay switch.

15. A system comprising:
an energy storage unit including:
a battery storing energy mechanically or chemically; and
an inverter coupled with the battery and converting direct current from the battery to alternating current for use by one or more loads; and
a control system coupled with one or more power sources, the energy storage unit, and the one or more loads, the control system including:
one or more electrical circuits including a first relay switch coupled with a second relay switch and an electrical contactor, the electrical contactor switchably coupling a utility grid power source with the one or more loads, the electrical contactor being electrically coupled with a first relay switch, the first relay switch being coupled with the energy storage unit, the second relay switch being coupled with one or more of the first relay switch and the electrical contactor; and
a controller communicatively coupled with the inverter and the second relay switch, the controller including a processor and a memory storing instructions that cause the controller to actuate the second relay switch.

16. The system of claim 15, wherein:
the controller is communicatively coupled with a remote server to determine a mode and actuates the second relay switch based on the mode to route power from the one or more power sources.

17. The system of claim 15, wherein the controller includes:
one or more processors coupled with a first communication port for communicating with the inverter, a second communication port for communicating with a remote server, and one or more electrical ports for actuating the second relay switch.

18. The system of claim 16, wherein:
the processor monitors data received from the inverter and a meter, process the monitored data, locally determine a fault, perform a local action based on the fault, and transmit fault data to the remote server.

19. A method comprising:
receiving, by a processor, a message from a remote server indicating an instruction for setting a mode of a control system, the control system routing current to an electrical system of a building from one or more of an energy storage unit and an electrical utility grid, wherein:
the energy storage unit includes:
a battery storing energy mechanically or chemically; and
an inverter coupled with the battery and converting direct current from the battery to alternating current for use by one or more loads; and
the control system is coupled with the energy storage unit, the electrical utility grid, and the electrical system of the building, the control system including:
one or more electrical circuits electrically coupling one or more electrical switches that route current from the one or more of the energy storage unit and the electrical utility grid based on the mode; and
a controller communicatively coupled with the inverter and the one or more electrical switches, the controller including the processor, the controller being communicatively coupled with the remote server;
setting, by the processor, the mode of the control system by actuating the one or more electrical switches; and
transmitting, by the processor, a status message based on the status of the control system to the remote server.
